(19) United States
(12) Patent Application Publication
(10) Pub. No.: US 2022/0350856 A1
(43) Pub. Date: Nov. 3, 2022

(54) METHODS AND SYSTEMS FOR FACILITATING PROVIDING RELIABLE AND VERIFIABLE RESPONSES TO QUERIES

(71) Applicant: Christopher Yang, San Jose, CA (US)

(72) Inventor: Christopher Yang, San Jose, CA (US)

(73) Assignee: Leader Software LLC, Redding, CA (US)

(21) Appl. No.: 17/243,532

(22) Filed: Apr. 28, 2021

(51) Int. Cl. G06F 16/957; G06N 5/02; G06F 16/9538; G06F 16/951

(52) U.S. Cl. CPC G06F 16/9574; G06N 5/02; G06F 16/9538; G06F 16/951

(57) ABSTRACT

Disclosed herein is a method for facilitating providing reliable and verifiable responses to queries. Accordingly, the method may include receiving, using a communication device, a content from a first device, analyzing, using a processing device, the content, determining, using the processing device, entities and a relationship between the entities based on the analyzing of the content, generating, using the processing device, a knowledge graph based on the entities and the relationship, storing, using a storage device, the knowledge graph, receiving, using the communication device, a query from a second device, analyzing, using the processing device, the query, identifying, using the processing device, a search entity and a search relationship based on the analyzing of the query, generating, using the processing device, a response using the knowledge graph based on the search entity and the search relationship, and transmitting, using the communication device, the response to the second device.

### TECHNICAL FIELD

Generally, the present disclosure relates to the field of data processing. More specifically, the present disclosure relates to methods and systems for facilitating providing reliable and verifiable responses to queries.

### BACKGROUND

The advent of the Internet has resulted in an information explosion like never before. With thousands of documents getting uploaded each day, the Internet has become the favorite place to search for information. A named entity (NE) search is one of the mechanisms to search for the right information. A named entity, generally, refers to a word or groups of words, such as the name of a company, a person, a location, a time, a date, a numerical value, etc. A named entity search may make the task of looking for relevant information relatively easier. However, searching for a complex named entity, such as a group of words, with multiple simple named entities is not a small task, given the corpus of search documents could potentially be millions of documents, if the search is being done on the internet.

Since the invention of the Internet, people have been continuously using keyword searches to find information and gain knowledge. For example, if the search query “How many awards, including Oscar, Emmy, Tony, etc. have Al Pacino won?” is inputted in a keyword-based search engine, then a user may find search result based on the search query using the keyword-based search engine, but this involves a lot of manual work and time. Additionally, knowledge-based websites such as Wikipedia™ and Quora™ may provide fast and reliable search results (or answers) for popular search queries (or questions) including the example above. However, finding an accurate search result requires time and effort of the user as such platforms facilitate answering only trending questions, wherein a question put up by the user may take time for someone to answer. Further, in an example, changing the question to “how many awards has X won in the last 50 years, where X can be an actor or actress?” makes it difficult for such services to provide all the answers promptly.

A number of methods have been reported for named entity extraction. Further, existing systems utilize machine learning techniques to train models to extract common named entities from high-quality newswire text. Such systems learn the models or rules from a hand-tagged training corpus, so the models and rules are only effective on a similar corpus and may perform poorly on other corpora with a different statistical characteristic or different genre or style. Due to the high cost of training models for each specific NE type, the existing systems approaches do not fulfill the need for a general named entity extraction.

Existing techniques for facilitating providing reliable and verifiable responses to queries are deficient with regard to several aspects. For instance, current technologies represent content in an essay format that may be easily readable but fail to be easily searchable. Further, there occurs a wastage of time as a lot of manual work has to be put in to get to the desired search result. Furthermore, current technologies do not provide verified search results obtained based on a search query, as a result of which there is a possibility of propagation of wrong information amongst users of the Internet. Further, to avoid such a scenario, fact checks need to be given a priority that may involve the users themselves to correct any information that may have been inappropriately mentioned in the search results.

Therefore, there is a need for improved methods and systems for facilitating providing reliable and verifiable responses to queries that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating providing reliable and verifiable responses to queries, in accordance with some embodiments. Accordingly, the method may include receiving, using a communication device, at least one content associated with at least one webpage from at least one first device. Further, the method may include analyzing, using a processing device, the at least one content of the at least one webpage. Further, the method may include determining, using the processing device, at least two entities and at least one relationship between the at least two entities present in the at least one content based on the analyzing of the at least one content. Further, the method may include generating, using the processing device, a knowledge graph based on the at least two entities and the at least one relationship. Further, the knowledge graph may include at least two nodes corresponding to the at least two entities and at least one edge connecting the at least two nodes corresponding to the at least one relationship between the least two entities. Further, the knowledge graph is searchable. Further, the method may include storing, using a storage device, the knowledge graph. Further, the method may include receiving, using the communication device, at least one query associated with the at least one content from at least one second device. Further, the method may include analyzing, using the processing device, the at least one query. Further, the method may include identifying, using the processing device, at least one of a search entity and a search relationship based on the analyzing of the at least one query. Further, the method may include generating, using the processing device, at least one response for the at least one query using the knowledge graph based on at least one of the search entity and the search relationship. Further, the at least one response is associated with at least one of the search entity and the search relationship. Further, the method may include transmitting, using the communication device, the at least one response to the at least one second device, in accordance with some embodiments.

Further disclosed herein is a system of facilitating providing reliable and verifiable responses to queries, in accordance with some embodiments. The system may include a communication device, a processing device, and a storage device. Further, the communication device may be configured for performing a step of receiving at least one content associated with at least one webpage from at least one first device. Further, the communication device may be configured for performing a step of receiving at least one query associated with the at least one content from at least one second device. Further, the communication device may be configured for performing a step of transmitting at least one response to the at least one second device. Further, the processing device may be communicatively coupled with the communication device. Further, the processing device may be configured for performing a step of analyzing the at least one content of the at least one webpage. Further, the processing device may be configured for performing a step of determining at least two entities and at least one relationship between the at least two entities present in the at least one content based on the analyzing of the at least one content. Further, the processing device may be configured for performing a step of generating a knowledge graph based on the at least two entities and the at least one relationship. Further, the knowledge graph may include at least two nodes corresponding to the at least two entities and at least one edge connecting the at least two nodes corresponding to the at least one relationship between the least two entities. Further, the knowledge graph is searchable. Further, the processing device may be configured for performing a step of analyzing the at least one query. Further, the processing device may be configured for performing a step of identifying at least one of a search entity and a search relationship based on the analyzing of the at least one query. Further, the processing device may be configured for performing a step of generating the at least one response for the at least one query using the knowledge graph based on at least one of the search entity and the search relationship. Further, the at least one response is associated with at least one of the search entity and the search relationship. Further, the storage device may be communicatively coupled with the processing device. Further. Further, the storage device may be configured for performing a step of storing the knowledge graph.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow chart of a method for facilitating providing reliable and verifiable responses to queries, in accordance with some embodiments.

FIG. 4 is a continuation flow chart of FIG. 3.

FIG. 5 is a flow chart of a method for identifying at least one of at least one related entity and a related relationship for facilitating providing the reliable and verifiable responses to the queries, in accordance with some embodiments.

FIG. 6 is a flow chart of a method for generating a modified knowledge graph for facilitating providing the reliable and verifiable responses to the queries, in accordance with some embodiments.

FIG. 7 is a flow chart of a method for associating at least one authenticity comment to the at least one supporting content and the at least one user relationship for facilitating providing the reliable and verifiable responses to the queries, in accordance with some embodiments.

FIG. 8 is a flow chart of a method for generating at least one supporting evidence for facilitating providing the reliable and verifiable responses to the queries, in accordance with some embodiments.

FIG. 9 is a flow chart of a method for generating at least one clarification comment for facilitating providing the reliable and verifiable responses to the queries, in accordance with some embodiments.

FIG. 10 is a flow chart of a method for determining at least one characteristic for facilitating providing the reliable and verifiable responses to the queries, in accordance with some embodiments.

FIG. 11 is a block diagram of a system for facilitating providing reliable and verifiable responses to queries, in accordance with some embodiments.

FIG. 12 is a flowchart of a method to facilitate identifying, annotating, and establishing relationships between named entities corresponding to webpages, in accordance with some embodiments.

FIG. 13 is a flowchart of a method to facilitate linking of the named entities corresponding to the webpages associated with a plurality of websites, in accordance with some embodiments.

FIG. 14 is a flowchart of a method for determining an acceptability of the at least two first entities and the at least one first relationship for facilitating providing the reliable and verifiable responses to the queries, in accordance with some embodiments.

FIG. 15 is a screenshot of a user interface of a web-based tool to facilitate identifying, annotating, and establishing relationships between named entities corresponding to webpages, in accordance with some embodiments.

FIG. 16 is a screenshot of a user interface of a sequence of pop-ups associated with the web-based tool, in accordance with some embodiments.

FIG. 17 is a screenshot of a user interface of a sequence of pop-ups associated with the web-based tool, in accordance with some embodiments.

FIG. 18 is a screenshot of a user interface of a sequence of pop-ups associated with the web-based tool, in accordance with some embodiments.

FIG. 19 is a screenshot of a user interface of the web-based tool, in accordance with some embodiments.

FIG. 20 is a screenshot of a user interface facilitating a disambiguated search by a user, in accordance with some embodiments.

FIG. 21 is a screenshot of a user interface facilitating the disambiguated search on the entity by the user, in accordance with some embodiments.

FIG. 22 is a screenshot of a user interface facilitating relationship search by a user, in accordance with some embodiments.

FIG. 23 is a screenshot of a user interface facilitating the relationship search by the user, in accordance with some embodiments.

FIG. 24 is a screenshot of a user interface facilitating provisioning of suggestions to a user, in accordance with some embodiments.

FIG. 25 is a screenshot of a user interface facilitating provisioning of the suggestions to the user, in accordance with some embodiments.

FIG. 26 is a screenshot of a user interface facilitating sharing of search results, in accordance with some embodiments.

FIG. 27 is a screenshot of a user interface of an application for facilitating searching of entities and relationships, in accordance with some embodiments.

FIG. 28 is a screenshot of a user interface of the application for facilitating searching of entities and relationships, in accordance with some embodiments.

FIG. 29 is a screenshot of a user interface of the application for facilitating searching of entities and relationships, in accordance with some embodiments.

FIG. 30 is a screenshot of a summary report of the application, in accordance with some embodiments.

FIG. 31 is a screenshot of a key stats of the summary report of the application, in accordance with some embodiments.

FIG. 32 is a screenshot of an activity log of the application, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating providing reliable and verifiable responses to queries, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating providing reliable and verifiable responses to queries. Further, the disclosed system may include a web-based tool to identify named entities and relations between entities in web pages. Further, since with invention of the internet, people have used keyword searches to find information and gain knowledge. For example, how many awards, including Oscar, Emmy, Tony, etc. have Al Pacino won? With enough time, one can find the answer to that question using a keyword-based search engine, but there's a lot of manual work.

Then came the knowledge based web site such as Wikipedia™ and Quora™, which provide fast and reliable answers for popular questions including the example above. However, these answers require time and effort from others so only popular questions can be answered. For example, if I change the question to how many awards has X won in the last 50 years, where X can be an actor or actress? It'll be impossible for these services to provide all the answers on time.

Accordingly, the web-based tool allows a user to identify or verify a named entity in a web page, usually on news websites, and create relations between named entities. Further, a named entity is a person, an organization, a location, a time, a living thing, or an event, etc. that can be used to identify someone, something, or some concept and be understood by most people with some basic knowledge.

For instance, in a news article, a user may follow these steps to create knowledge in the knowledge base:
1. Open up the tool from the web browser:
2. Identify named entity: NASA's Artemis program
3. Identify named entity: Christina Koch
4. Create a relationship between these two entities as Artemis Program->select ->Christina Koch:

The same can also be done for Artemis Program ->select->Jessica Meir.

Once submitted by the user, the entities and relations are stored in a Graph Database for searches. For example, if someone searches “Who has Artemis Program selected so far?” the answer will return at least Christina Koch and Jessica Meir as results because of the information provided by this article.

Note what's stored in the database are metadata about the data, i.e., the named entities and relations are metadata about this news article, not the news article itself. It's not an extraction of data from a copyrighted source; it's almost identical to how other search engines extract keywords from web pages and store the keywords-to-page connection.

The disclosed system allows user to do a “one-click search” by putting the cursor over highlighted named entities or relations in a web page and get the related search results:

The search result can be “shareable search results” with others i.e. to prove or disprove an argument by using the search result as supporting evidence. For example, by combining the information from the example page and other pages I can share the search result of “Who are the women selected by the Artemis program” with anyone and provide links to these articles as supporting evidence.

The limitation of the existing approaches is that they represent knowledge in the essay format which is very readable but not very easily searchable. A lot of manual work has to be done to get to the answer.

Further, the disclosed system may represent knowledge in its simplest format: a connection between 2 named entities e.g. Al Pacino->won->Academy Award. With enough connections like this, the disclosed system may be configured for creating a knowledge graph that is both searchable and verifiable.

The disclosed system may allow the users to participate in web indexing. Further, no longer do we have to rely on bots to crawl the internet, all the users of the internet can contribute to the knowledge graph and add to the indexes. This allows everyone to directly create, update and correct the search results.

Further, the disclosed system may allow the users to directly contribute to web indexes. Further, the disclosed system may allow the user to search by one click on the highlighted named entities. Further, the disclosed system may allow the user to graph search for everything on the internet, not just social network communities such as FB. Further, the disclosed system may allow the user to news search and search on newsworthy entities and relations. Further, the disclosed system may be configured for sharing the search result with others because the search results to the same query are identical for all users.

Further, the disclosed system may be configured for facilitating identifying, annotating, and establishing relationships between named entities corresponding to webpages. Further, the disclosed system describes a web-based tool that may allow a user to identify and/or verify a named entity in a web page, usually on news websites, and create relations between identified and/or verified named entities on the web page. Further, the web page may be associated with a website that may be accessed on a user device associated with the user. Further, the named entity may include names associated with, but not limited to, a person, an organization, a location, a time, a living thing, or an event, etc. that may be used to identify someone, something, or some concept that may be understood by most people with some basic knowledge of content available on the corresponding webpage. Further, in some embodiments, the disclosed methods and systems may be embodied in a form of a web-browser extension. Further, the web-based tool may facilitate identifying numerous named entities in the web page subsequent to enabling the web-based tool. Further, in some embodiments, the numerous named entities may be identified based on preprocessing of the web page using an artificial intelligence (AI) engine. Further, the numerous named entities may be highlighted subsequent to the identifying. Further, each of the numerous named entities may be annotated automatically upon the enabling based on named entity information available on an external database such as, but not limited to, Wikipedia™ using the AI engine. Further, the user may remove the annotation corresponding to one or more named entities in the web page and subsequently cite or annotate with a new annotation that may facilitate a more precise description of the one or more named entities. Further, the user may then verify the annotation corresponding to the one or more named entities that may be highlighted, in an instance, with a green underscore subsequent to the verifying. Further, in some embodiments, the web-based tool may facilitate participation of a plurality of users accessing the web page in providing the more precise information based on the identifying and/or the verifying the numerous named entities on respective user devices. Further, the participating, in an instance, may correspond to crowdsourcing that may enable the plurality of users to participate in web indexing. Further, the crowdsourcing may eliminate usage of bots to surf the Internet such that the plurality of users may contribute to the knowledge graph and add to indexes that may allow the plurality of users to directly create, update and correct the search results.

Further, the present disclosure describes a capability for allowing users to flag issues with the annotation of content and allowing users with appropriate permission to review it and approve or reject the annotation. This allows maintaining the quality of the content associated with the annotation.

Further, in some embodiments, the AI engine may suggest one or more named entity information wherein the user may choose to delete at least one named entity information of the one or more named entity information that does not go along with the description of the corresponding named entity. Further, the user may establish a relationship between the each of the one or more named entities subsequent to the verifying. Further, the one or more name entities may include at least one structured named entity and at least one object named entity such that the at least one object named entity may establish a relationship with the at least one structured named entity using a keyword. Further, the keyword, in an instance, may include a verb. Further, one or more of such relationships may be accessed by the user using a user interface associated with the web-based tool. Further, the one or more such relationships may create a knowledge graph that may be both searchable and verifiable.

Further, the disclosed system may be configured for storing the identified and/or verified numerous entities and relationships in a graph database such that the graph database may facilitate ease of navigation corresponding to a particular named entity in the webpage. Further, in some embodiments, the disclosed methods and systems may facilitate provisioning of a search engine that may generate a much precise search result than existing search engines such as Google™, Bing™, DuckDuckGo™, etc. based on a query searched by the user. Further, the search engine may utilize the one or more named entities for generating a compilation of the much precise search results. Further, a database associated with the web-based tool may store the one or more entities and the relationships in a form of metadata corresponding to the one or more named entities i.e., the one or more named entities and the relationships are the metadata corresponding to the content of the webpage, not the content itself. Further, the metadata, in an instance, may include the named entity information associated with the one or more entities. Alternatively, the metadata may not exactly refer to extracted data from a copyrighted source but may be almost identical to how other search engines extract keywords from the plurality of web pages and store the keywords-to-page connection. For example, if a user searches “Who has Artemis Program selected so far?”, then a search result will return at least one of Christina Koch and Jessica Meir based on information provided by content of the respective webpage. Further, the disclosed methods and systems allow the user to do a “one-click search” by selecting highlighted one or more named entities or relationships in the web page and get corresponding search results.

Further, the disclosed system may be configured for facilitating sharing of the search results with one or more other users. Further, the sharing, in an instance, may allow the one or more other users to prove or disprove an argument by using the search results as supporting evidence. For instance, based on a combination of the information based on the content provided by the web pages, the search result “Who are the women selected by the Artemis program?” may be shared with the one or more other users, and additionally may also provide links to the content as the supporting evidence.

Reputation may be defined by how others perceive you, not how you see yourself. This is very different from social media where popularity is often confused for reputation.

With Leader search (an exemplary embodiment of the disclosed system herein), a person or organization may defend their reputation by replying to a certain news reporting and pin the article to the top of the search result so everyone can always see their comments.

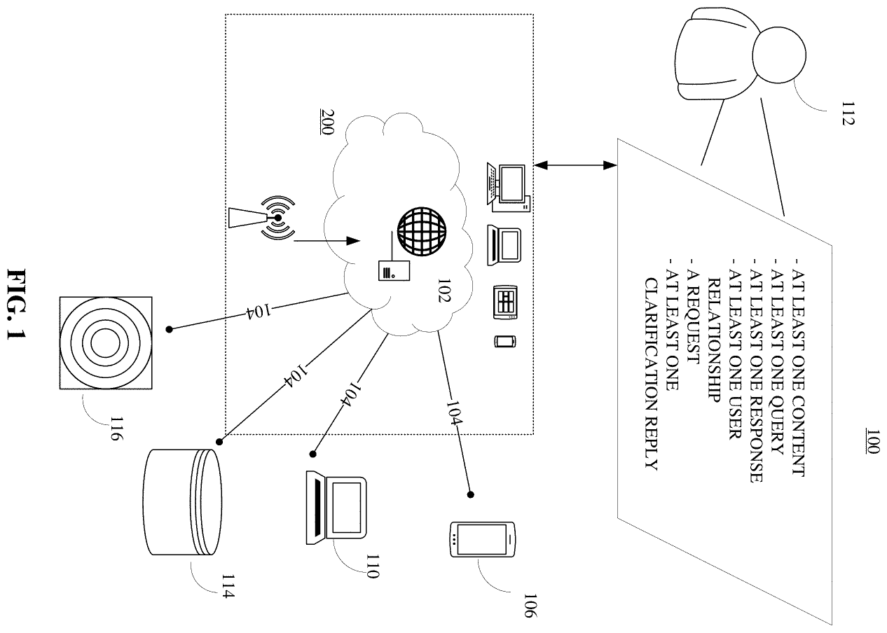

Referring now to figures, FIG. 1 is an illustration of an online platform 100 consistent with various embodiments of the present disclosure. By way of non-limiting example, the online platform 100 to enable facilitating providing reliable and verifiable responses to queries may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

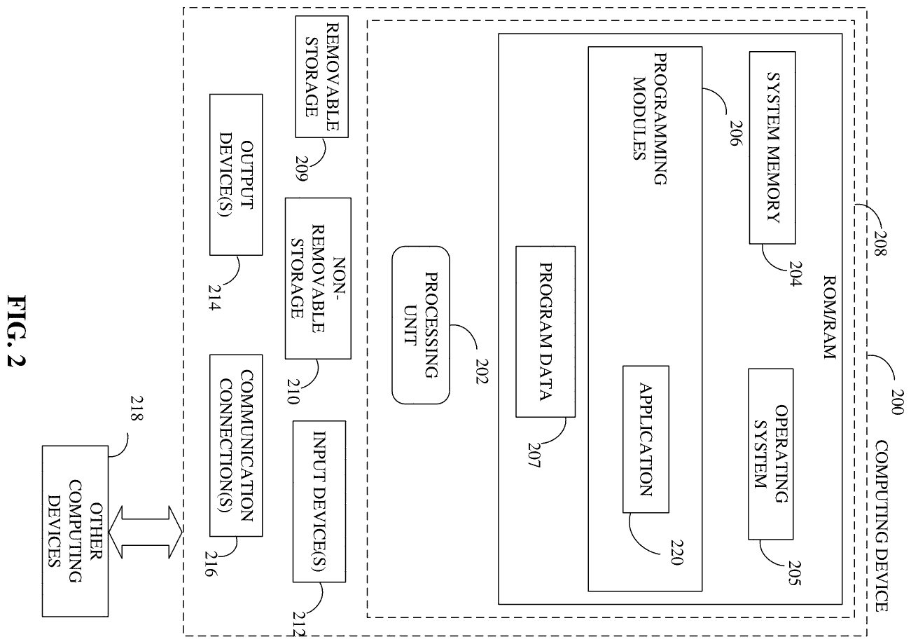

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200′s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

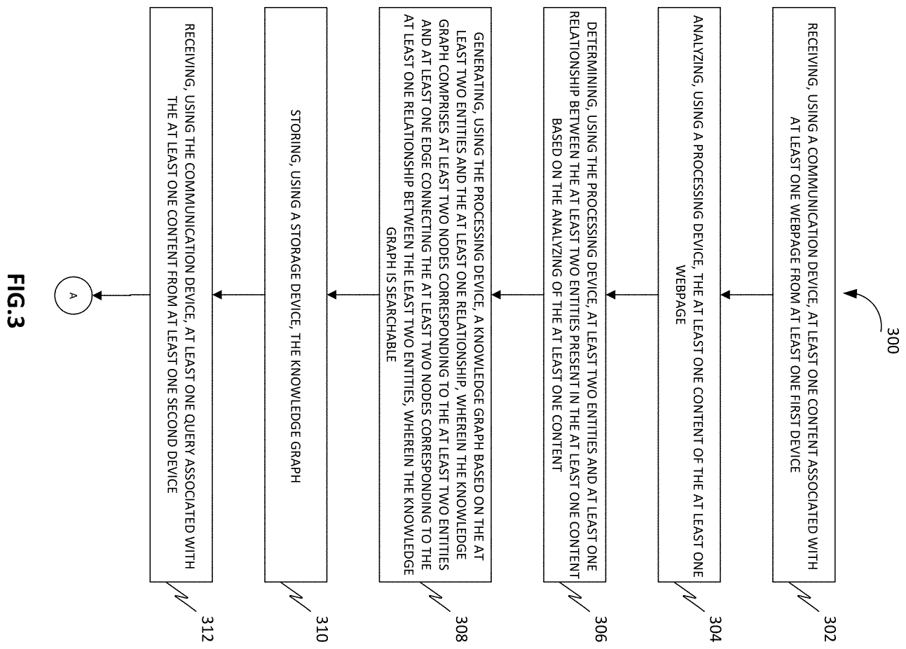

FIG. 3 is a flow chart of a method 300 for facilitating providing reliable and verifiable responses to queries, in accordance with some embodiments. Accordingly, at 302, the method 300 may include receiving, using a communication device, at least one content associated with at least one webpage from at least one first device. Further, the at least one content, in an instance, may include one or more of textual content, audio content, visual content, audio-visual content, and so on. Further, in some embodiments, the at least one content may include news articles, journals, blogs, web portals, etc.

Further, at 304, the method 300 may include analyzing, using a processing device, the at least one content of the at least one webpage.

Further, at 306, the method 300 may include determining, using the processing device, at least two entities and at least one relationship between the at least two entities present in the at least one content based on the analyzing of the at least one content. Further, an entity of the at least two entities may include a named entity. Further, the named entity may include a name of a company, a person, a location, a time, a date, a numerical value, etc.

Further, at 308, the method 300 may include generating, using the processing device, a knowledge graph based on the at least two entities and the at least one relationship. Further, the knowledge graph may include at least two nodes corresponding to the at least two entities and at least one edge connecting the at least two nodes corresponding to the at least one relationship between the least two entities. Further, the knowledge graph may be searchable.

Further, at 310, the method 300 may include storing, using a storage device, the knowledge graph.

Further, at 312, the method 300 may include receiving, using the communication device, at least one query associated with the at least one content from at least one second device.

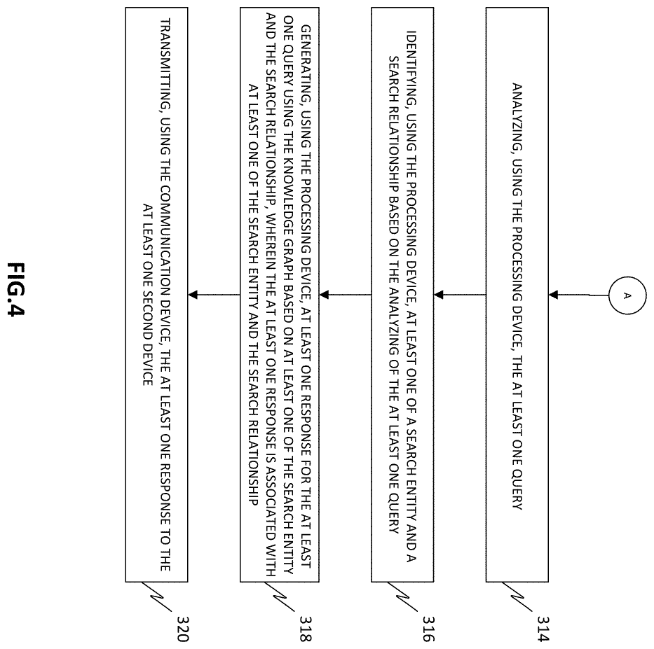

FIG. 4 is a continuation flow chart of FIG. 3, in accordance with some embodiments. Accordingly, at 314, the method 300 may include analyzing, using the processing device, the at least one query.

Further, at 316, the method 300 may include identifying, using the processing device, at least one of a search entity and a search relationship based on the analyzing of the at least one query.

Further, at 318, the method 300 may include generating, using the processing device, at least one response for the at least one query using the knowledge graph based on at least one of the search entity and the search relationship. Further, the at least one response may be associated with at least one of the search entity and the search relationship.

Further, at 320, the method 300 may include transmitting, using the communication device, the at least one response to the at least one second device.

In some embodiments, the at least one query may include at least one of a search entity indication and a search relationship indication. Further, the identifying of at least one of the search entity and the search relationship may be based on at least one of the search entity indication and the search relationship indication.

Further, in some embodiments, the method 300 may include determining, using the processing device, at least one attribute for each entity of the at least two entities based on the analyzing of the at least one content. Further, the at least one attribute of a first entity of the at least two entities uniquely maps the first entity to a second entity of the at least two entities using the at least one relationship. Further, the at least one attribute of the second entity uniquely maps the second entity to the first entity using the at least one relationship. Further, the generating of the knowledge graph may be based on the determining of the at least one attribute for the each entity. Further, the knowledge graph may include the at least one attribute associated with the each entity. Further, in an embodiment, the at least one query may include a search entity identifier. Further, the search entity identifier does not uniquely identify the search entity. Further, the identifying of the search entity may include identifying a plurality of search entities associated with the search identifier. Further, the generating of the at least one response for the at least one query may be based on the each of the plurality of search entities. Further, the at least one response may be associated with the plurality of search entities.

Further, in some embodiments, the method 300 may include transmitting, using the communication device, the at least two entities and the at least one relationship between the at least two entities to the at least one second device. Further, the method 300 may include receiving, using the communication device, at least one issue associated with at least two first entities of the at least two entities and at least one first relationship of the at least one relationship between the at least two first entities from the at least one second device. Further, the at least one issue corresponds to a discrepancy associated with the at least two first entities and the at least one first relationship. Further, the method 300 may include flagging, using the processing device, the at least two first entities and the at least one first relationship between the at least two first entities based on the at least one issue. Further, the method 300 may include transmitting, using the communication device, the at least two first entities, the at least one first relationship between the at least two first entities, and the at least one issue to at least one authorized device associated with at least one authorized user. Further, the method 300 may include receiving, using the communication device, at least one review response associated with the at least two first entities and the at least one first relationship from the at least one authorized device. Further, the method 300 may include determining, using the processing device, an acceptability of the at least two first entities and the at least one first relationship between the at least two first entities based on the at least one review response. Further, the generating of the knowledge graph may be based on the determining of the acceptability.

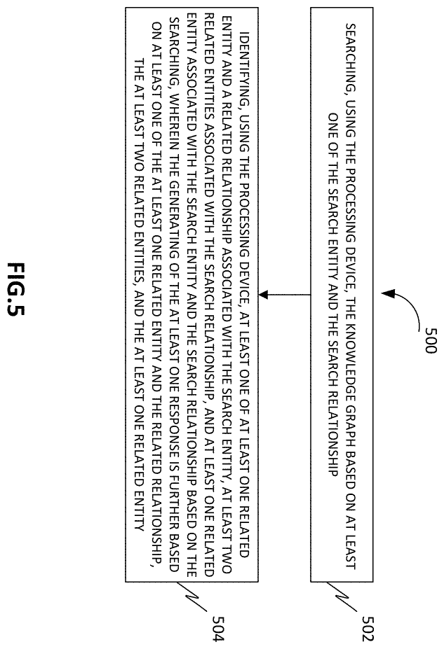

FIG. 5 is a flow chart of a method 500 for identifying at least one of at least one related entity and a related relationship for facilitating providing the reliable and verifiable responses to the queries, in accordance with some embodiments. Accordingly, at 502, the method 500 may include searching, using the processing device, the knowledge graph based on at least one of the search entity and the search relationship.

Further, at 504, the method 500 may include identifying, using the processing device, at least one of at least one related entity and a related relationship associated with the search entity, at least two related entities associated with the search relationship, and at least one related entity associated with the search entity and the search relationship based on the searching. Further, the generating of the at least one response may be based on at least one of the at least one related entity and the related relationship, the at least two related entities, and the at least one related entity.

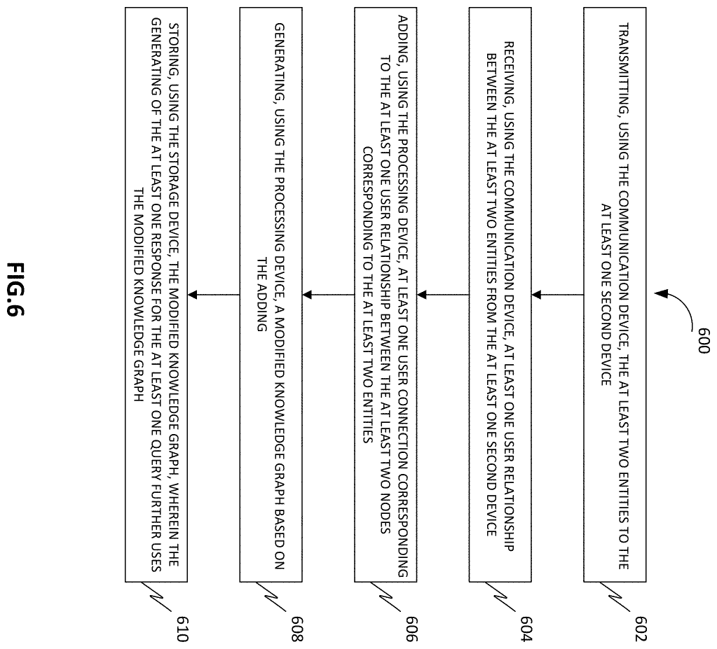

FIG. 6 is a flow chart of a method 600 for generating a modified knowledge graph for facilitating providing the reliable and verifiable responses to the queries, in accordance with some embodiments. Accordingly, at 602, the method 600 may include transmitting, using the communication device, the at least two entities to the at least one second device.

Further, at 604, the method 600 may include receiving, using the communication device, at least one user relationship between the at least two entities from the at least one second device.

Further, at 606, the method 600 may include adding, using the processing device, at least one user connection corresponding to the at least one user relationship between the at least two nodes corresponding to the at least two entities.

Further, at 608, the method 600 may include generating, using the processing device, a modified knowledge graph based on the adding.

Further, at 610, the method 600 may include storing, using the storage device, the modified knowledge graph. Further, the generating of the at least one response for the at least one query uses the modified knowledge graph.

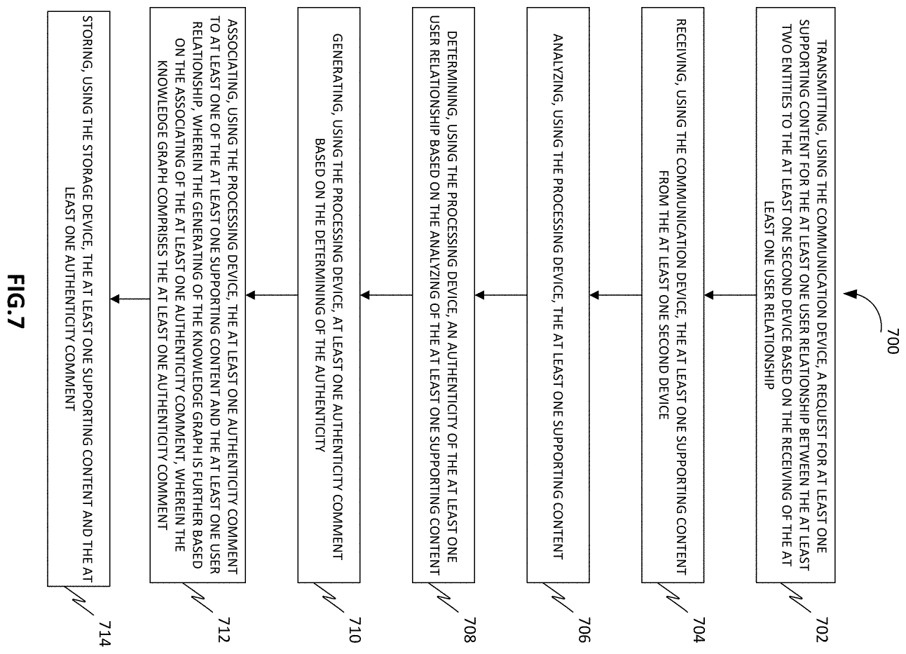

FIG. 7 is a flow chart of a method 700 for associating at least one authenticity comment to the at least one supporting content and the at least one user relationship for facilitating providing the reliable and verifiable responses to the queries, in accordance with some embodiments. Accordingly, at 702, the method 700 may include transmitting, using the communication device, a request for at least one supporting content for the at least one user relationship between the at least two entities to the at least one second device based on the receiving of the at least one user relationship.

Further, at 704, the method 700 may include receiving, using the communication device, the at least one supporting content from the at least one second device.

Further, at 706, the method 700 may include analyzing, using the processing device, the at least one supporting content.

Further, at 708, the method 700 may include determining, using the processing device, an authenticity of the at least one user relationship based on the analyzing of the at least one supporting content.

Further, at 710, the method 700 may include generating, using the processing device, at least one authenticity comment based on the determining of the authenticity.

Further, at 712, the method 700 may include associating, using the processing device, the at least one authenticity comment to at least one of the at least one supporting content and the at least one user relationship. Further, the generating of the knowledge graph may be based on the associating of the at least one authenticity comment. Further, the knowledge graph may include the at least one authenticity comment.

Further, at 714, the method 700 may include storing, using the storage device, the at least one supporting content and the at least one authenticity comment.

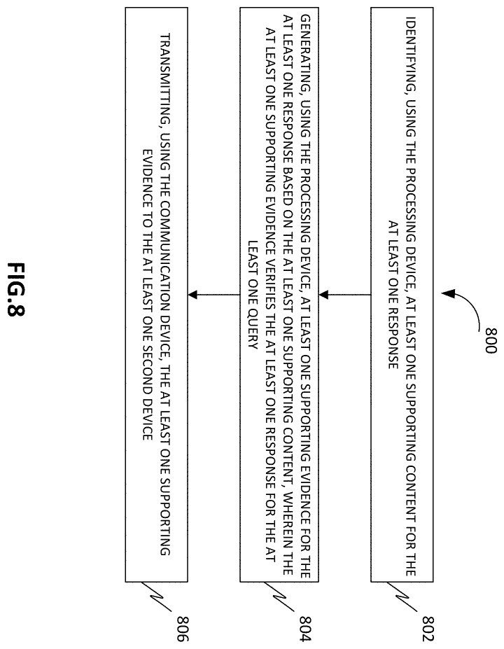

FIG. 8 is a flow chart of a method 800 for generating at least one supporting evidence for facilitating providing the reliable and verifiable responses to the queries, in accordance with some embodiments. Accordingly, at 802, the method 800 may include identifying, using the processing device, at least one supporting content for the at least one response.

Further, at 804, the method 800 may include generating, using the processing device, at least one supporting evidence for the at least one response based on the at least one supporting content. Further, the at least one supporting evidence verifies the at least one response for the at least one query.

Further, at 806, the method 800 may include transmitting, using the communication device, the at least one supporting evidence to the at least one second device.

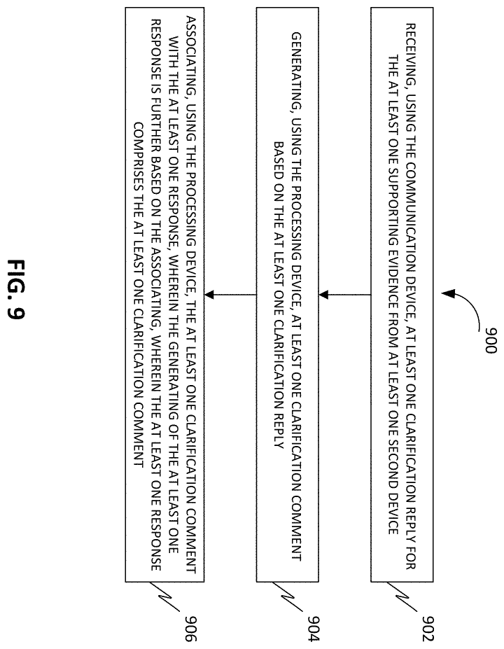

FIG. 9 is a flow chart of a method 900 for generating at least one clarification comment for facilitating providing the reliable and verifiable responses to the queries, in accordance with some embodiments. Accordingly, at 902, the method 900 may include receiving, using the communication device, at least one clarification reply for the at least one supporting evidence from at least one second device.

Further, at 904, the method 900 may include generating, using the processing device, at least one clarification comment based on the at least one clarification reply.

Further, at 906, the method 900 may include associating, using the processing device, the at least one clarification comment with the at least one response. Further, the generating of the at least one response may be based on the associating. Further, the at least one response may include the at least one clarification comment.

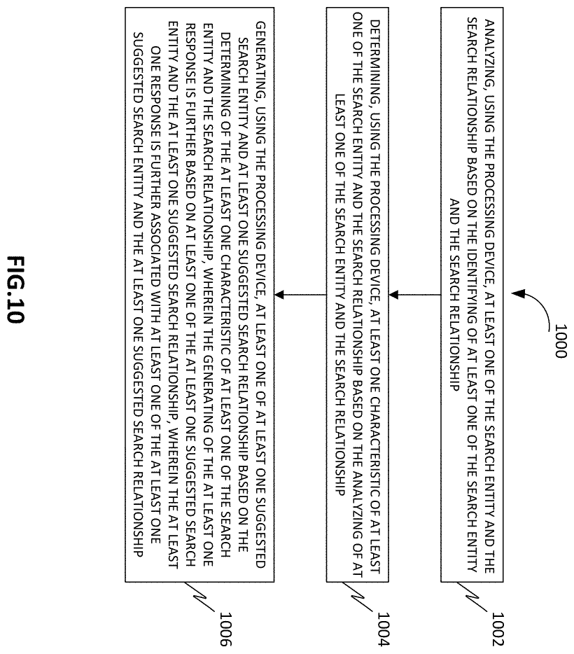

FIG. 10 is a flow chart of a method 1000 for determining at least one characteristic for facilitating providing the reliable and verifiable responses to the queries, in accordance with some embodiments. Accordingly, at 1002, the method 1000 may include analyzing, using the processing device, at least one of the search entity and the search relationship based on the identifying of at least one of the search entity and the search relationship.

Further, at 1004, the method 1000 may include determining, using the processing device, at least one characteristic of at least one of the search entity and the search relationship based on the analyzing of at least one of the search entity and the search relationship.

Further, at 1006, the method 1000 may include generating, using the processing device, at least one of at least one suggested search entity and at least one suggested search relationship based on the determining of the at least one characteristic of at least one of the search entity and the search relationship. Further, the generating of the at least one response may be based on at least one of the at least one suggested search entity and the at least one suggested search relationship. Further, the at least one response may be associated with at least one of the at least one suggested search entity and the at least one suggested search relationship.

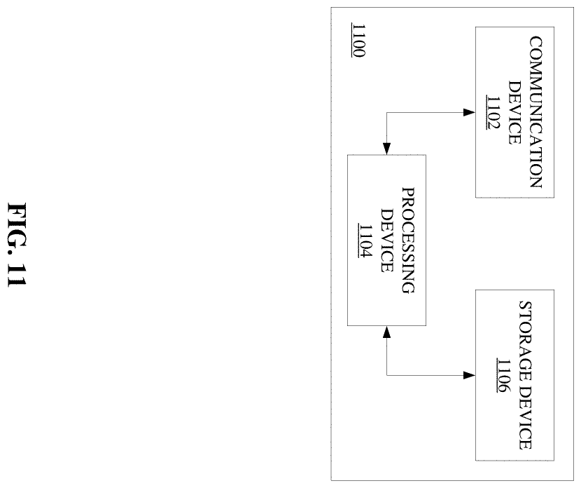

FIG. 11 is a block diagram of a system 1100 for facilitating providing reliable and verifiable responses to queries, in accordance with some embodiments. Accordingly, the system 1100 may include a communication device 1102, a processing device 1104, and a storage device 1106.

Further, the communication device 1102 may be configured for performing a step of receiving at least one content associated with at least one webpage from at least one first device. Further, the communication device 1102 may be configured for performing a step of receiving at least one query associated with the at least one content from at least one second device. Further, the communication device 1102 may be configured for performing a step of transmitting at least one response to the at least one second device.

Further, the processing device 1104 may be communicatively coupled with the communication device 1102. Further, the processing device 1104 may be configured for performing a step of analyzing the at least one content of the at least one webpage. Further, the processing device 1104 may be configured for performing a step of determining at least two entities and at least one relationship between the at least two entities present in the at least one content based on the analyzing of the at least one content. Further, the processing device 1104 may be configured for performing a step of generating a knowledge graph based on the at least two entities and the at least one relationship. Further, the knowledge graph may include at least two nodes corresponding to the at least two entities and at least one edge connecting the at least two nodes corresponding to the at least one relationship between the least two entities. Further, the knowledge graph may be searchable. Further, the processing device 1104 may be configured for performing a step of analyzing the at least one query. Further, the processing device 1104 may be configured for performing a step of identifying at least one of a search entity and a search relationship based on the analyzing of the at least one query. Further, the processing device 1104 may be configured for performing a step of generating the at least one response for the at least one query using the knowledge graph based on at least one of the search entity and the search relationship. Further, the at least one response may be associated with at least one of the search entity and the search relationship.

Further, the storage device 1106 may be communicatively coupled with the processing device 1104. Further, the storage device 1106 may be configured for performing a step of storing the knowledge graph.

Further, in some embodiments, the at least one query may include at least one of a search entity indication and a search relationship indication. Further, the identifying of at least one of the search entity and the search relationship may be based on at least one of the search entity indication and the search relationship indication.

In some embodiments, the processing device 1104 may be configured for performing a step of searching the knowledge graph based on at least one of the search entity and the search relationship. Further, the processing device 1104 may be configured for performing a step of identifying at least one of at least one related entity and a related relationship associated with the search entity, at least two related entities associated with the search relationship, and at least one related entity associated with the search entity and the search relationship based on the searching. Further, the generating of the at least one response may be based on at least one of the at least one related entity and the related relationship, the at least two related entities, and the at least one related entity.

In some embodiments, the communication device 1102 may be configured for performing a step of transmitting the at least two entities to the at least one second device. Further, the communication device 1102 may be configured for performing a step of receiving at least one user relationship between the at least two entities from the at least one second device. Further, the processing device 1104 may be configured for performing a step of adding at least one user connection corresponding to the at least one user relationship between the at least two nodes corresponding to the at least two entities. Further, the processing device 1104 may be configured for performing a step of generating a modified knowledge graph based on the adding. Further, the storage device 1106 may be configured for performing a step of storing the modified knowledge graph. Further, the generating of the at least one response for the at least one query uses the modified knowledge graph. Further, in an embodiment, the communication device 1102 may be configured for performing a step of transmitting a request for at least one supporting content for the at least one user relationship between the at least two entities to the at least one second device based on the receiving of the at least one user relationship. Further, the communication device 1102 may be configured for performing a step of receiving the at least one supporting content from the at least one second device. Further, the processing device 1104 may be configured for performing a step of analyzing the at least one supporting content. Further, the processing device 1104 may be configured for performing a step of determining an authenticity of the at least one user relationship based on the analyzing of the at least one supporting content. Further, the processing device 1104 may be configured for performing a step of generating at least one authenticity comment based on the determining of the authenticity. Further, the processing device 1104 may be configured for performing a step of associating the at least one authenticity comment to at least one of the at least one supporting content and the at least one user relationship. Further, the generating of the knowledge graph may be based on the associating of the at least one authenticity comment. Further, the knowledge graph may include the at least one authenticity comment. Further, the storage device 1106 may be configured for performing a step of storing the at least one supporting content and the at least one authenticity comment.

In some embodiments, the processing device 1104 may be configured for performing a step of identifying at least one supporting content for the at least one response. Further, the processing device 1104 may be configured for performing a step of generating at least one supporting evidence for the at least one response based on the at least one supporting content. Further, the at least one supporting evidence verifies the at least one response for the at least one query. Further, the communication device 1102 may be configured for performing a step of transmitting the at least one supporting evidence to the at least one second device. Further, in an embodiment, the communication device 1102 may be configured for performing a step of receiving at least one clarification reply for the at least one supporting evidence from at least one second device. Further, the processing device 1104 may be configured for performing a step of generating at least one clarification comment based on the at least one clarification reply. Further, the processing device 1104 may be configured for performing a step of associating the at least one clarification comment with the at least one response. Further, the generating of the at least one response may be based on the associating. Further, the at least one response may include the at least one clarification comment.

In some embodiments, the processing device 1104 may be configured for performing a step of determining at least one attribute for each entity of the at least two entities based on the analyzing of the at least one content. Further, the at least one attribute of a first entity of the at least two entities uniquely maps the first entity to a second entity of the at least two entities using the at least one relationship. Further, the at least one attribute of the second entity uniquely maps the second entity to the first entity using the at least one relationship. Further, the generating of the knowledge graph may be based on the determining of the at least one attribute for the each entity. Further, the knowledge graph may include the at least one attribute associated with the each entity. Further, in an embodiment, the at least one query may include a search entity identifier. Further, the search entity identifier does not uniquely identify the search entity. Further, the identifying of the search entity may include identifying a plurality of search entities associated with the search identifier. Further, the generating of the at least one response for the at least one query may be based on the each of the plurality of search entities. Further, the at least one response may be associated with the plurality of search entities.

In some embodiments, the processing device 1104 may be configured for performing a step of analyzing at least one of the search entity and the search relationship based on the identifying of at least one of the search entity and the search relationship. Further, the processing device 1104 may be configured for performing a step of determining at least one characteristic of at least one of the search entity and the search relationship based on the analyzing of at least one of the search entity and the search relationship. Further, the processing device 1104 may be configured for performing a step of generating at least one of at least one suggested search entity and at least one suggested search relationship based on the determining of the at least one characteristic of at least one of the search entity and the search relationship. Further, the generating of the at least one response may be further based on at least one of the at least one suggested search entity and the at least one suggested search relationship. Further, the at least one response may be associated with at least one of the at least one suggested search entity and the at least one suggested search relationship.

Further, in some embodiments, the communication device 1102 may be configured for transmitting the at least two entities and the at least one relationship between the at least two entities to the at least one second device. Further, the communication device 1102 may be configured for receiving at least one issue associated with at least two first entities of the at least two entities and at least one first relationship of the at least one relationship between the at least two first entities from the at least one second device. Further, the at least one issue corresponds to a discrepancy associated with the at least two first entities and the at least one first relationship. Further, the communication device 1102 may be configured for transmitting the at least two first entities, the at least one first relationship between the at least two first entities, and the at least one issue to at least one authorized device associated with at least one authorized user. Further, the communication device 1102 may be configured for receiving at least one review response associated with the at least two first entities and the at least one first relationship from the at least one authorized device. Further, the processing device 1104 may be configured for flagging the at least two first entities and the at least one first relationship between the at least two first entities based on the at least one issue. Further, the processing device 1104 may be configured for determining an acceptability of the at least two first entities and the at least one first relationship between the at least two first entities based on the at least one review response. Further, the generating of the knowledge graph may be based on the determining of the acceptability.

In further embodiments, a method for facilitating providing reliable and verifiable responses to queries is disclosed. Further, the method may include transmitting, using a communication device (such as the communication device 1102), at least one content to at least one first device.

Further, the method may include receiving, using the communication device, at least two entity identifications and at least one relationship identification associated with the at least one content from the at least one first device.

Further, the method may include analyzing, using a processing device (such as the processing device 1104), the at least one content based on the at least two entity identifications and the at least one relationship identification.

Further, the method may include identifying, using the processing device, at least two entities and at least one relationship between the at least two entities based on the analyzing of the at least one content.

Further, the method may include generating, using the processing device, a knowledge graph based on the at least two entities and the at least one relationship, wherein the knowledge graph may include at least two nodes corresponding to the at least two entities and at least one edge connecting the at least two nodes corresponding to the at least one relationship between the least two entities, wherein the knowledge graph is searchable.

Further, the method may include storing, using a storage device, the knowledge graph (such as the storage device 1106).

Further, the method may include receiving, using the communication device, at least one query associated with the at least one content from at least one second device.

Further, the method may include analyzing, using the processing device, the at least one query.

Further, the method may include identifying, using the processing device, at least one of a search entity and a search relationship based on the analyzing of the at least one query.

Further, the method may include searching, using the processing device, the knowledge graph based on at least one of the search entity and the search relationship.

Further, the method may include generating, using the processing device, at least one response for the at least one query based on the searching, wherein the at least one response is associated with at least one of the search entity and the search relationship.

Further, the method may include transmitting, using the communication device, the at least one response to the at least one second device.

Further, in some embodiments, the method may include generating, using the processing device, a list of recommended two entities and a list of recommended relationships based on the analyzing of the at least one content. Further, the method may include transmitting, using the communication device, the list of recommended two entities and the list of recommended relationships to the at least one first device. Further, the method may include receiving, using the communication device, a selection of at least two entities from the list of recommended two entities and a selection of at least one relationship between the at least two entities from the list of recommended relationships from the at least one first device, wherein the identifying of the at least one entities and the at least one relationship between the at least two entities may be based on the selection of the at least two entities and the selection of the at least one relationship.

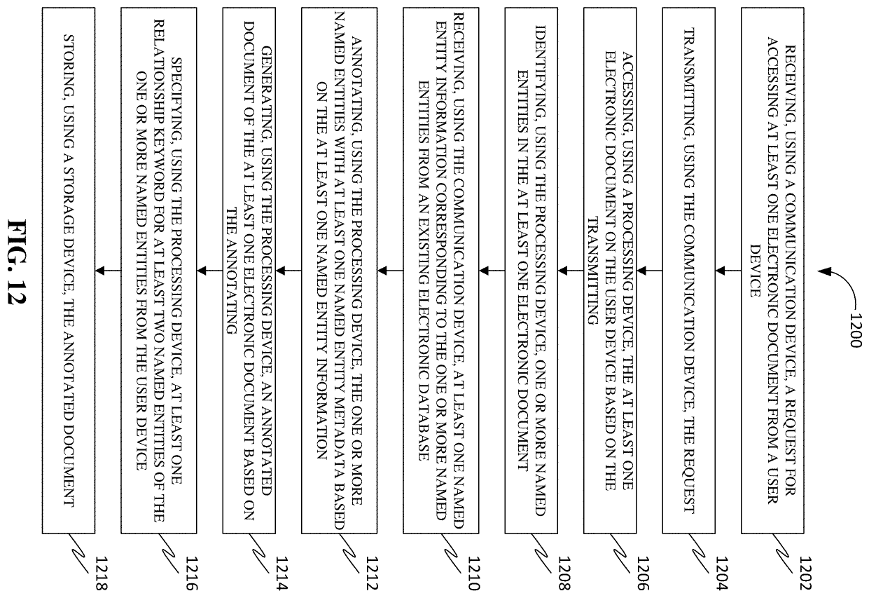

FIG. 12 is a flowchart of a method 1200 to facilitate identifying, annotating, and establishing relationships between named entities corresponding to webpages, in accordance with some embodiments. Accordingly, at 1202, the method 1200 may include a step of receiving, using a communication device, a request for accessing at least one electronic document from a user device. Further, the request for accessing, in an instance, may facilitate fetching the at least one electronic document from a server associated with the webpages. Further, the server may host content corresponding to the at least one electronic document. Further, the content, in an instance, may include one or more content in digital form such as, but not limited to, one or more of textual content, audio content, visual content, audio-visual content, and so on. Further, in some embodiments, the at least one electronic document may include textual content corresponding to, but not limited to, news articles, journals, blogs, web portals, etc. in a form of a plurality of webpages. Further, in some embodiments, a website may include the at least one electronic document that may be included in a webpage corresponding to the website. Further, the user device may be associated with a user. Further, the user may navigate through one or more webpages corresponding to the website using the user device to search the at least one electronic document. Further, the at least one electronic document may be based on a choice of the content that the user may want to consume. Further, examples of the user device may include devices such as, but not limited to, a smartphone, a portable computer such as a laptop, tablet, etc., a wearable computer such as a smartwatch, a PC, etc. Further, in some embodiments, the identifying, the annotating, and/or the establishing of the relationship between the named entities corresponding to the webpages may be facilitated using a web-based tool. Further, the web-based tool may run on a web browser such that the web browser may be installed on a user device prior to running of the web-based tool. Further, the web-based tool may advantageously utilize a user interface of the web browser such that the web-based tool may be configured to facilitate aforementioned tasks in the one or more webpages displayed using the web-browser on the user device. Further, the web-based tool may facilitate the aforementioned tasks based on the running on the web browser. Further, in some embodiments, the web-based tool may be enabled prior to performing the aforementioned tasks. Further, in some embodiments, the web-based tool may be enabled automatically based on a list of websites that the web-based tool may be configured to perform the aforementioned tasks. Further, the web-based tool may be executed remotely based on a remote server associated with the web-based tool. Further, each of the aforementioned tasks may be facilitated using a user interface of the web-based tool. Further, the user may choose to disable the web-based tool using the user interface of the web-based tool. Further, the web-based tool may include such as, but not limited to, a web browser extension, a software application, etc. that may be executed remotely on the remote server such that the web browser may facilitate the running of the web-based tool. Further, in some embodiments, the identifying, the annotating, and/or the establishing of the relationship between the named entities corresponding to the webpages may be facilitated using a software application that may be installed on the user device. Further, the software application, in an instance, may include an in-app browser that may facilitate the aforementioned tasks based on displaying of the webpages.

Further, at 1204, the method 1200 may include a step of transmitting, using the communication device, the request. Further, the request for accessing the at least one electronic document corresponding to the webpages may be transmitted to the server associated with the webpages.

Further, at 1206, the method 1200 may include a step of accessing, using a processing device, the at least one electronic document on the user device based on the transmitting. Further, the accessing may be based on the fetching of the at least one electronic document from the server associated with the webpages. Further, in some embodiments, the at least one electronic document may be displayed on the user device using the web browser installed on the user device.

Further, at 1208, the method 1200 may include a step of identifying, using the processing device, one or more named entities in the at least one electronic document. Further, the identifying may include determining the one or more named entities in the at least one electronic document. Further, in some embodiments, the one or more named entities may be identified subsequent to the enabling of the web-based tool. Further, in some embodiments, the one or more named entities may be identified automatically subsequent to displaying the at least one electronic document on the user device. Further, the one or more named entities, in an instance, may include names associated with, but not limited to, a person, an organization, a location, a time, a living thing, or an event, etc. that may identify someone, something or some concept such that the at least one electronic document may be understood by a plurality of users. Further, in some embodiments, the one or more named entities may include simple and/or complex named entities. For example, if the at least one electronic document includes a webpage describing Artemis program associated with National Aeronautics and Space Administration (NASA) from a news portal CBS News™, then the simple named entities may include, such as, but not limited to, name of a person (e.g., astronauts including Christina Koch, Jessica Meir, etc.), location (e.g., place of study corresponding to the astronauts including North Carolina, Maine, etc.), etc. may be identified. Further, the complex named entities, such as, but not limited to, mission names (e.g., 2024 moon landing, etc.), project names (e.g., Artemis program, etc.) may be identified. Further, in some embodiments, the one or more named entities may be highlighted subsequent to the identifying. Further, the highlighting may be based on importance of the one or more named entities in the at least one electronic document. Further, in some embodiments, the highlighting may be based on a search query associated with the one or more named entities inputted in a search engine. Further, the search engine, in an instance, may connect the search query with the one or more named entities that may have been identified by the web-tool. Further, the search engine may result in one or more precise results based on the connecting such that the one or more precise results may include a compilation of information based on the search query instead of displaying a number of webpages based on the search query. Further, the search engine may include such as, but not limited to, Google™, Bing™, DuckDuckGo™, etc. Further, the highlighting, in an instance, may include underscoring the one or more named entities. Further, in some embodiments, the underscoring may be based on one or more different colors such as blue, black, yellow, etc. Further, in some embodiments, the identifying may be based on an artificial intelligence (AI) engine that may automatically detect and/or highlight the one or more named entities based on the importance. Further, the one or more named entities may facilitate a better understanding of the content corresponding to the at least one electronic document to the plurality of users. Further, in some embodiments, the user may wish to identify a named entity that may have not been identified by the AI engine. Further, in such a case, the user may choose to identify the named entity. For example, the user may hover cursor over the named entity using the user device, and based on clicking on the named entity, the user may identify the corresponding named entity based on the user interface of the web browser and the web-based tool.

Further, at 1210, the method 1200 may include a step of receiving, using the communication device, at least one named entity information corresponding to the one or more named entities from an existing electronic database. Further, the receiving may be based on the identified one or more named entities. Further, in some embodiments, the AI engine may automatically fetch the at least one named entity information corresponding to the identified one or more named entities from the existing electronic database. Further, the existing electronic database may be associated with one or more websites such as Wikipedia™, Encyclopedia™, Britannica™, etc. Further, in some embodiments, the user may wish to provide the at least one named entity information for at least one named entity of the one or more named entities. Further, the providing, in an instance, may be facilitated by the user interface of the web-based tool. Further, in some embodiments, the providing may include inserting a link that may redirect to a webpage that may include the at least one named entity information corresponding to the at least one named entity. Further, in some embodiments, the user may choose to add the at least one named entity information for the at least one named entity. Further, in some embodiments, the one or more named entities may receive one or more named entity information from the existing electronic database. Further, in such a case, the user may choose to delete at least one named entity information of the one or more named entity information such that the at least one named entity information may not correspond to the one or more named entities.

Further, at 1212, the method 1200 may include a step of annotating, using the processing device, the one or more named entities with at least one named entity metadata based on the at least one named entity information. Further, the at least one named entity metadata may include any data that may provide precise information corresponding to the one or more named entities. Further, the precise information, in an instance, may include a section of the at least one named entity information that may convey an overview associated with the one or more named entities such that the user may understand reference corresponding to the one or more named entities in the at least one electronic document, Further, the at least one named entity metadata may include one or more of digital content such as, but not limited to, textual content, audio content, visual content, audio-visual content, and so on. Further, in some embodiments, the at least one named entity metadata may be displayed in a form of pop-ups. Further, the displaying, in an instance, may be based on the hovering the cursor over the one or more named entities and/or clicking the one or more named entities. Further, in a case, if the at least one named entity metadata is accurate corresponding to the one or more named entities, then the user may choose to verify the one or more named entities. Further, the annotating, in an instance, may be subsequent to verifying the one or more named entities by the user. Further, in some embodiments, the one or more verified named entities may be highlighted in the at least one electronic document. Further, the highlighting, in an instance, may include underscoring the one or more verified named entities in the at least one electronic document. Further, the underscoring may be based on one or more different colors such as, but not limited to, green, yellow, orange, etc.

Further, at 1214, the method 1200 may include a step of generating, using the processing device, an annotated document of the at least one electronic document based on the annotating. Further, the annotated document may include the one or more named entities that may have been identified and/or verified by the plurality of users accessing the at least one electronic document on the webpages on respective user devices. Further, in some embodiments, the annotated document may facilitate creating of a graph database of the one or more named entities that may link the one or more named entities included in the plurality of webpages in accordance of references based on the at least one named entity information in the at least one electronic document. Further, the graph database, in an instance, may include the one or more entities as nodes of the graph database. Further, the nodes may facilitate linking of the plurality of webpages. Further, in some embodiments, the plurality of webpages may be associated with a website. Further, in some embodiments, the plurality of webpages may be associated with a plurality of websites hosted by a plurality of servers on a communication network, such as the Internet. Further, in some embodiments, the web-based tool may facilitate participating of the plurality of users for one or more of creating, updating, and/or deleting of the at least one named entity metadata corresponding to the one or more named entities in the plurality of webpages. Further, in a case, if the user may have wrongly annotated the at least one named entity, then the participating of the plurality of users may facilitate annotating the one or more named entities with at least one accurate named entity metadata based on receiving the at least one named entity information. Further, the at least one accurate named entity metadata may provide improved web indexing such that the one or more precise search results may be generated corresponding to the search query inputted in the search engine by the user.

Further, at 1216, the method 1200 may include a step of specifying, using the processing device, at least one relationship keyword for at least two named entities of the one or more named entities from the user device. Further, the specifying may facilitate establishing of a relationship between the at least two named entities. Further, the specifying, in an instance, may be based on the identified and/or the verified one or more named entities. Further, the user may specify the at least one relationship keyword between the at least two named entities of the one or more named entities. Further, a first named entity of the at least two named entity may be referred to as a structured named entity. Further, a second named entity of the at least two named entities may be referred to as an object named entity. Further, one or more object named entities in the at least one electronic document may be specified with at least one relationship keyword that may facilitate the establishing of a relationship with at least one structured name entity. For example, if the at least one electronic document includes the webpage describing the Artemis program associated with the National Aeronautics and Space Administration (NASA) from the news portal CBS News™, then the object named entity may include names of the astronauts participating in the mission (i.e., Christina Koch, Jessica Meir, etc.), and the structured named entity may include name of the mission (i.e., Artemis program). Further, the specifying, in an instance, may be facilitated using the user interface of the web-based tool. Further, the at least one relationship keyword may provide a relation between the one or more object named entities and the at least one structured named entity. Further, in some embodiments, the at least one relationship keyword may include a verb. Further, the at least one relationship keyword may be chosen based on a prediction such that the at least one relationship keyword may be inclusive of a search query that may be inputted in future by the plurality of users in the search engine. For example, if the search query is “Who has Artemis Program selected so far?”, then the search results may display “Christina Koch” and/or “Jessica Meir”, wherein the at least one relationship keyword “select” may be the predictive keyword that may establish a relationship between the at least two named entities.

Further, at 1218, the method 1200 may include a step of storing, using a storage device, the annotated document.

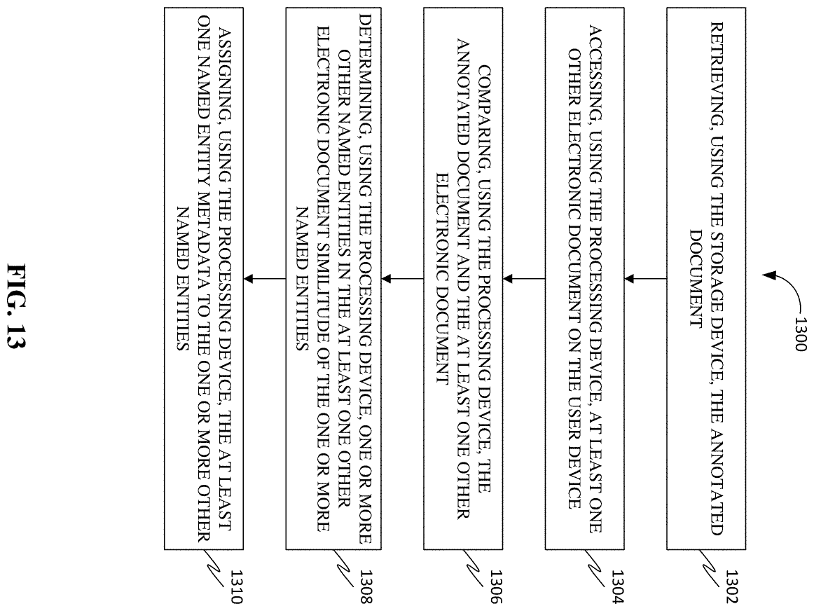

FIG. 13 is a flowchart of a method 1300 to facilitate linking of the named entities corresponding to the webpages associated with a plurality of websites, in accordance with some embodiments. Accordingly, at 1302, the method 1300 may include a step of retrieving, using the storage device, the annotated document. Further, the annotated document may include the one or more named entities corresponding to the at least one electronic document such that the one or more named entities may have been identified, verified, and specified with at least one relationship keyword between the one or more named entities.

Further, at 1304, the method 1300 may include a step of accessing, using the processing device, at least one other electronic document on the user device. Further, the at least one other electronic document may include textual content corresponding to, but not limited to, news articles, journals, blogs, web portals, etc. in a form of a plurality of webpages.

Further, at 1306, the method 1300 may include a step of comparing, using the processing device, the annotated document and the at least one other electronic document. Further, the comparing, in an instance, may include performing a similarity check between the at least one other document and the annotated document such that each word of the at least one other electronic document may be matched with the annotated document using the AI engine. Further, in some embodiments, a set of algorithms may process the at least one other electronic document and the annotated document such that the set of algorithms may be executed remotely on a server associated with the web-based tool. Further, the processing may facilitate the comparing of the aforementioned documents.

Further, at 1308, the method 1300 may include a step of determining, using the processing device, one or more other named entities in the at least one other electronic document similitude of the one or more named entities.

Further, at 1310, the method 1300 may include a step of assigning, using the processing device, the at least one named entity metadata to the one or more other named entities.

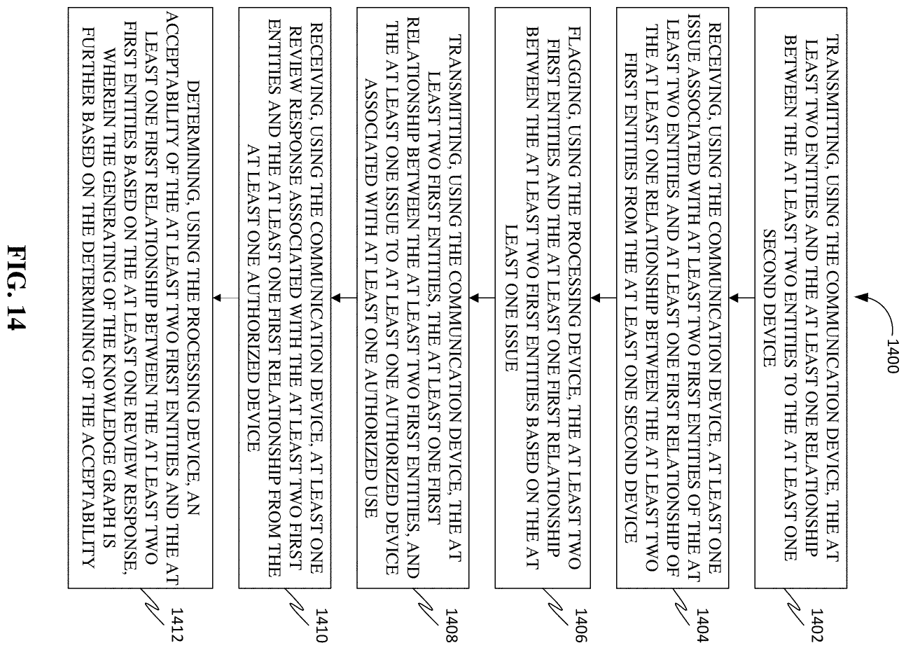

FIG. 14 is a flowchart of a method 1400 for determining an acceptability of the at least two first entities and the at least one first relationship for facilitating providing the reliable and verifiable responses to the queries, in accordance with some embodiments. Further, at 1402, the method 1400 may include transmitting, using the communication device, the at least two entities and the at least one relationship between the at least two entities to the at least one second device.

Further, at 1404, the method 1400 may include receiving, using the communication device, at least one issue associated with at least two first entities of the at least two entities and at least one first relationship of the at least one relationship between the at least two first entities from the at least one second device. Further, the at least one issue corresponds to a discrepancy associated with the at least two first entities and the at least one first relationship.

Further, at 1406, the method 1400 may include flagging, using the processing device, the at least two first entities and the at least one first relationship between the at least two first entities based on the at least one issue.

Further, at 1408, the method 1400 may include transmitting, using the communication device, the at least two first entities, the at least one first relationship between the at least two first entities, and the at least one issue to at least one authorized device associated with at least one authorized user.

Further, at 1410, the method 1400 may include receiving, using the communication device, at least one review response associated with the at least two first entities and the at least one first relationship from the at least one authorized device.

Further, at 1412, the method 1400 may include determining, using the processing device, an acceptability of the at least two first entities and the at least one first relationship between the at least two first entities based on the at least one review response. Further, the generating of the knowledge graph may be based on the determining of the acceptability.

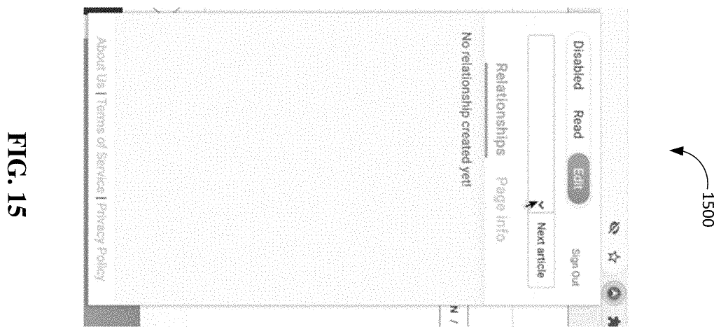

FIG. 15 is a screenshot of a user interface 1500 of a web-based tool to facilitate identifying, annotating, and establishing relationships between named entities corresponding to webpages, in accordance with some embodiments.

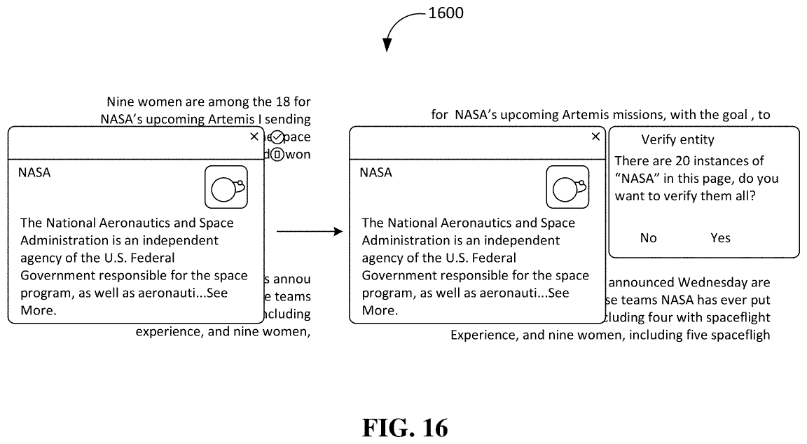

FIG. 16 is a screenshot of a user interface 1600 of a sequence of pop-ups associated with the web-based tool, in accordance with some embodiments.

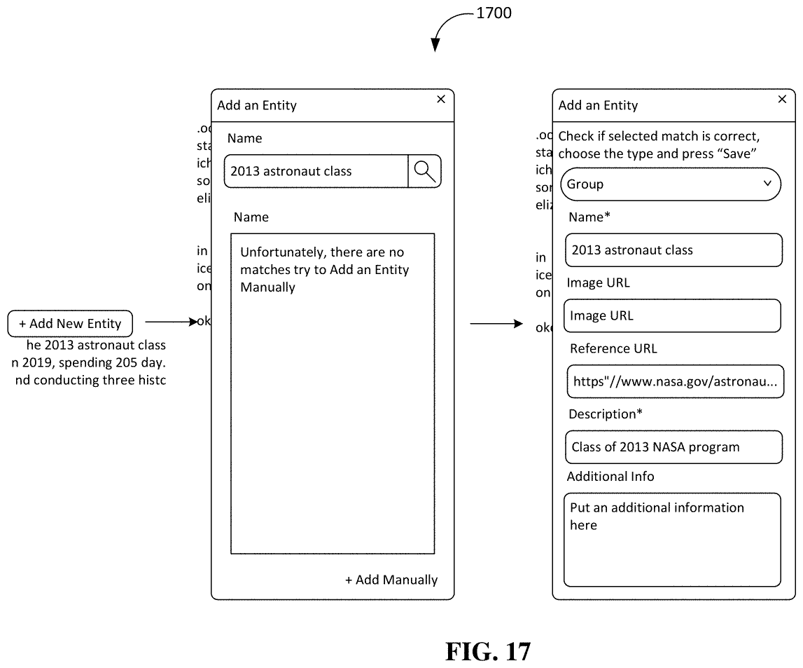

FIG. 17 is a screenshot of a user interface 1700 of a sequence of pop-ups associated with the web-based tool, in accordance with some embodiments.

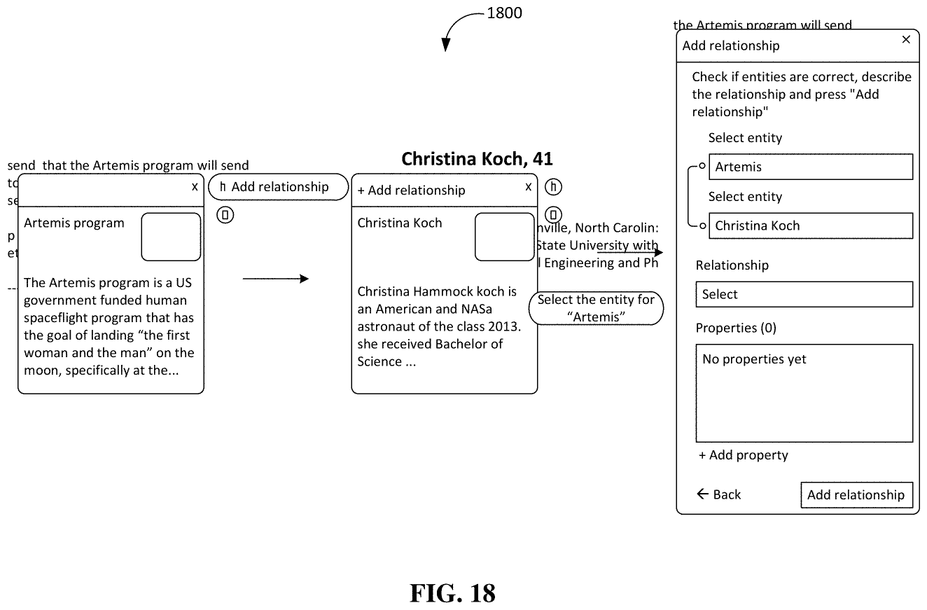

FIG. 18 is a screenshot of a user interface 1800 of a sequence of pop-ups associated with the web-based tool, in accordance with some embodiments.

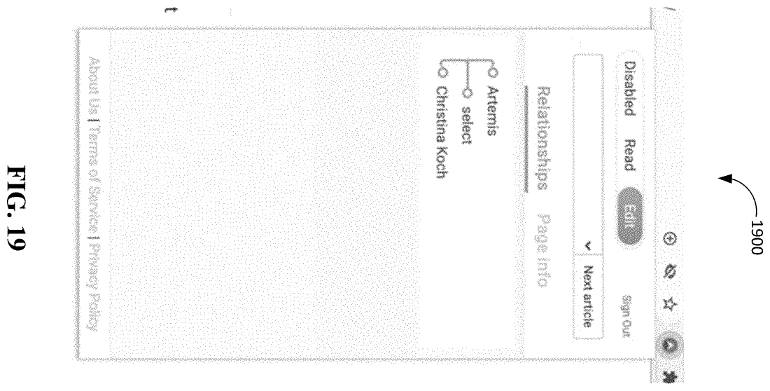

FIG. 19 is a screenshot of a user interface 1900 of the web-based tool, in accordance with some embodiments.

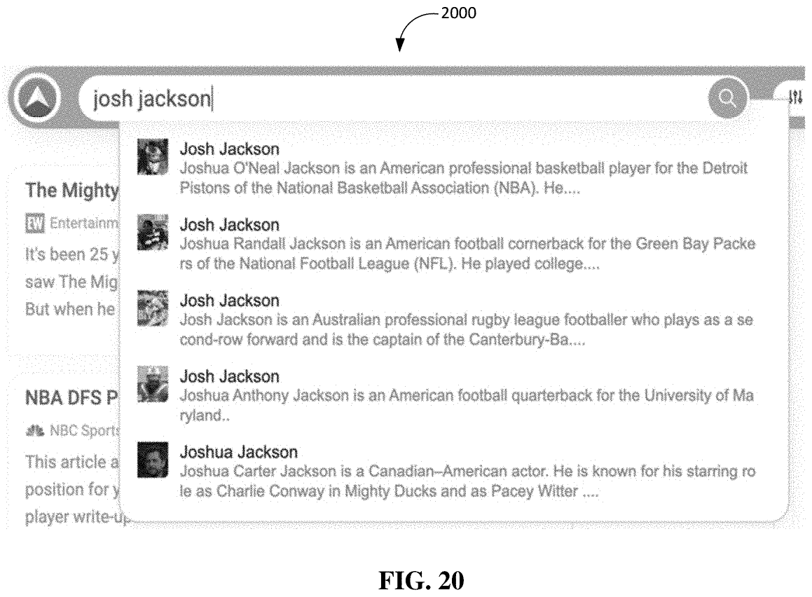

FIG. 20 is a screenshot of a user interface 2000 facilitating a disambiguated search by a user, in accordance with some embodiments. Accordingly, in an instance, the user may perform the disambiguated search for the entity, for instance, “Josh Jackson”.

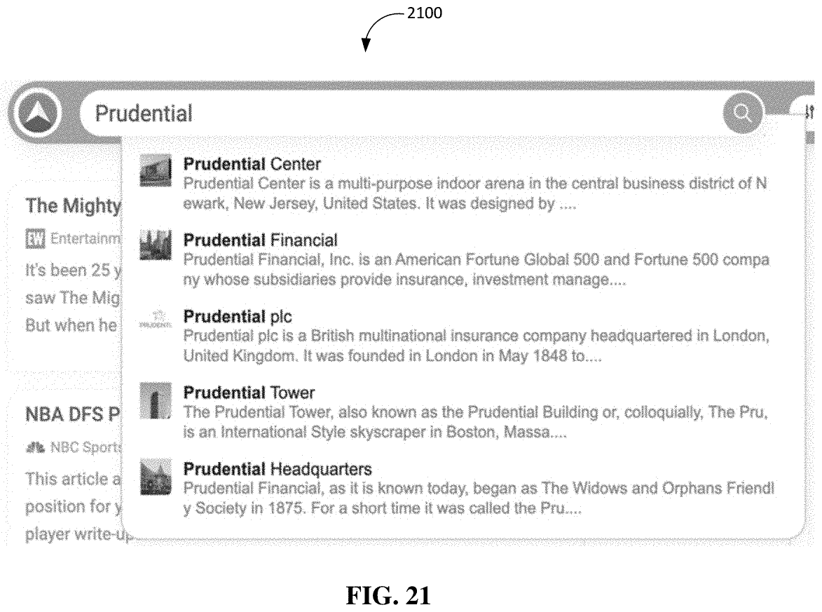

FIG. 21 is a screenshot of a user interface 2100 facilitating the disambiguated search on the entity by the user, in accordance with some embodiments. Accordingly, the user may define which “Josh Jackson” to search and get only the results for a particular “Josh Jackson”. Further, the user may define using keywords such as an organization (in an instance may be Prudential). Companies no longer have to make up words to differentiate themselves from the others e.g. Doordash™, Airbnb™, Youtube™. Companies like Leader may never be confused with another company by the same name.

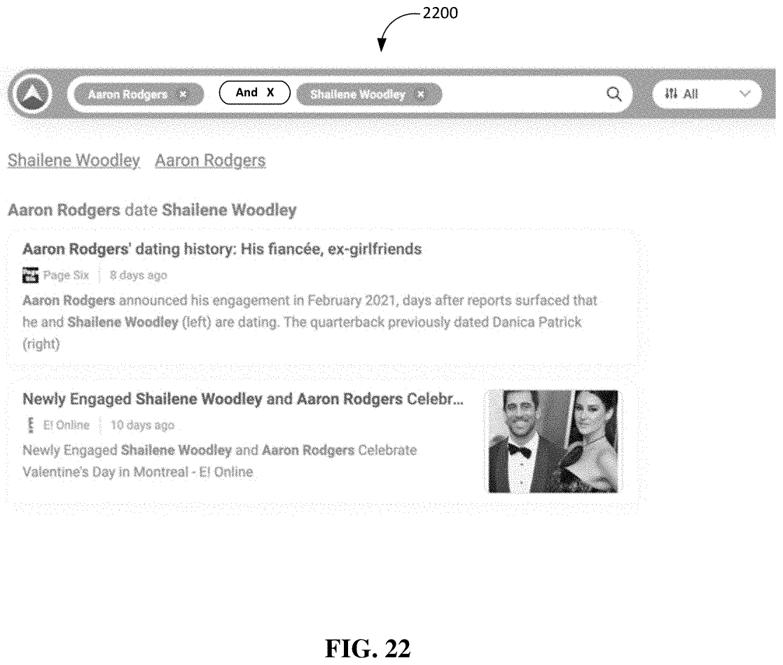

FIG. 22 is a screenshot of a user interface 2200 facilitating relationship search by a user, in accordance with some embodiments. Accordingly, the user may search for a relationship between two entities.

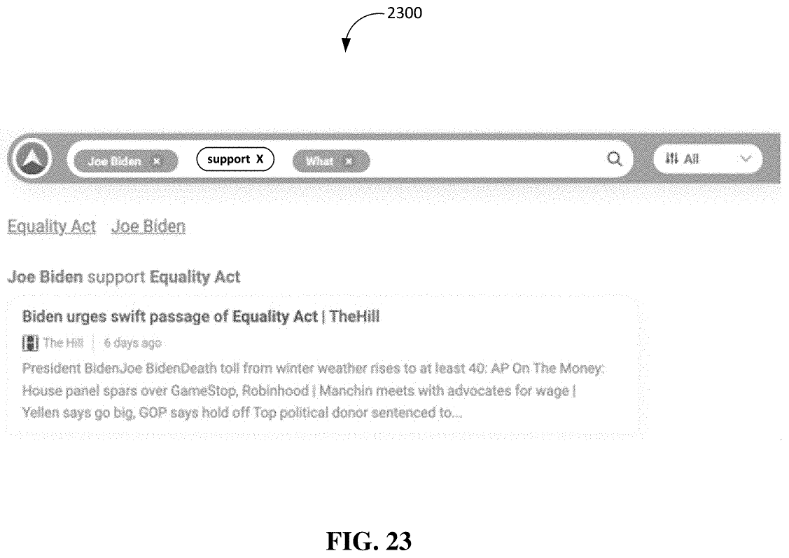

FIG. 23 is a screenshot of a user interface 2300 facilitating the relationship search by the user, in accordance with some embodiments. Accordingly, the user may provide an entity and a relationship type and search for what entities are connected.

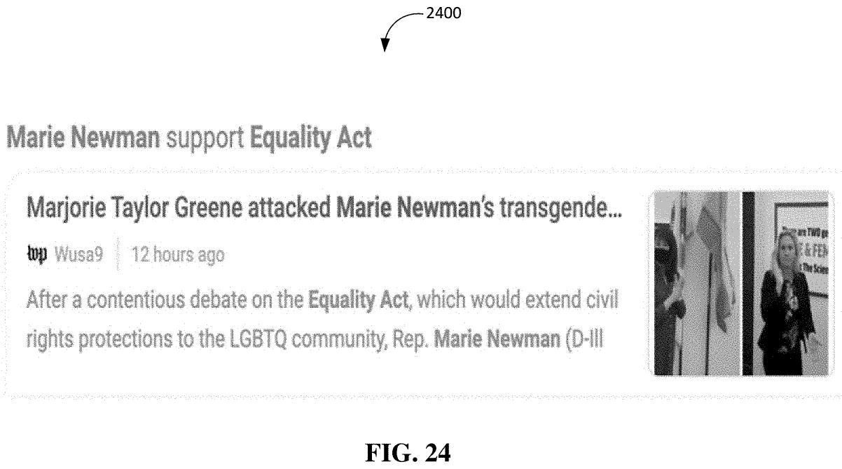

FIG. 24 is a screenshot of a user interface 2400 facilitating provisioning of suggestions to a user, in accordance with some embodiments. Accordingly, search engines (such as the Leader Search) may also recommend relevant searches to the user that they may not know about. In the above instance, the search engine may suggest there are others who also support the Equality act.

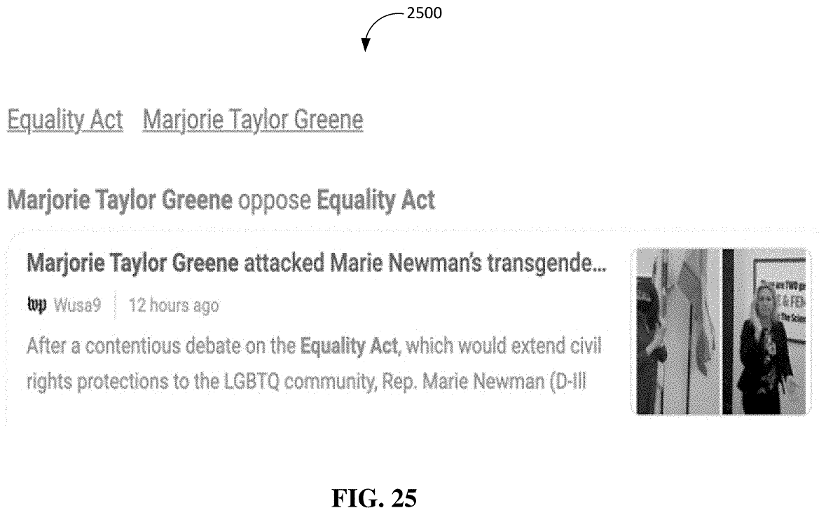

FIG. 25 is a screenshot of a user interface 2500 facilitating provisioning of the suggestions to the user, in accordance with some embodiments. Accordingly, the search engines may provide suggestions including people that oppose the equality act.

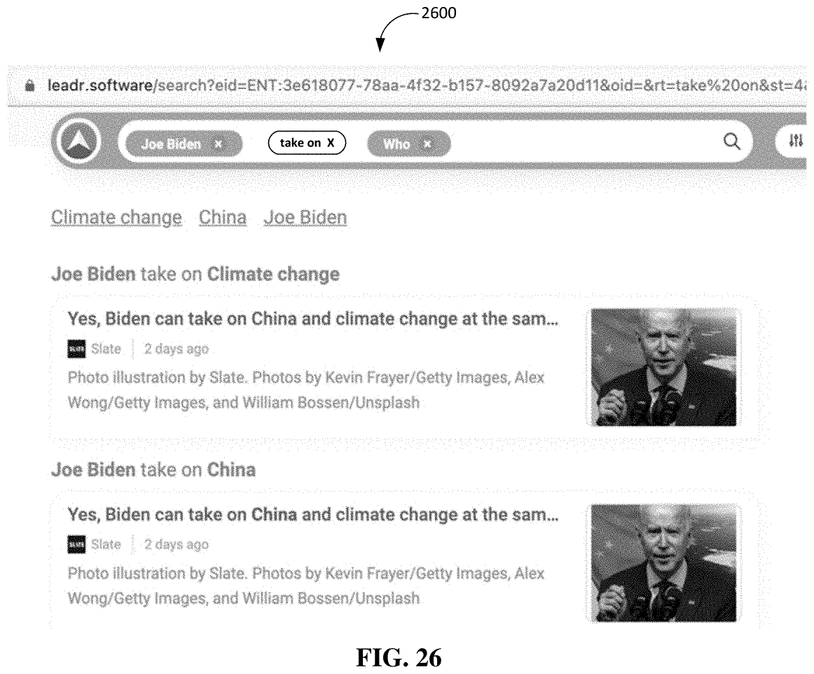

FIG. 26 is a screenshot of a user interface 2600 facilitating sharing of search results, in accordance with some embodiments. Accordingly, the search results may be shared and other users may see exactly the same search results. For instance, if a user may want to tell his friends that Joe Biden is taking on China and Climate change at the same time and the user have evidence to back it up, the user may just send an URL and the other users may see the evidence for themselves: Further, as the user contributes to the search index, the user may identify what may be fact-based reporting and what are opinionated articles. Further, the search result may display an icon next to the opinion-based articles so the user can tell the difference.

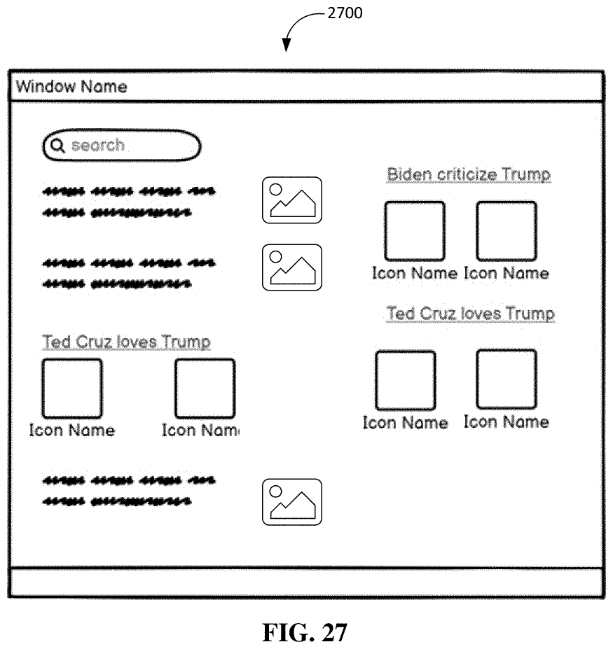

FIG. 27 is a screenshot of a user interface 2700 of an application for facilitating searching of entities and relationships, in accordance with some embodiments.

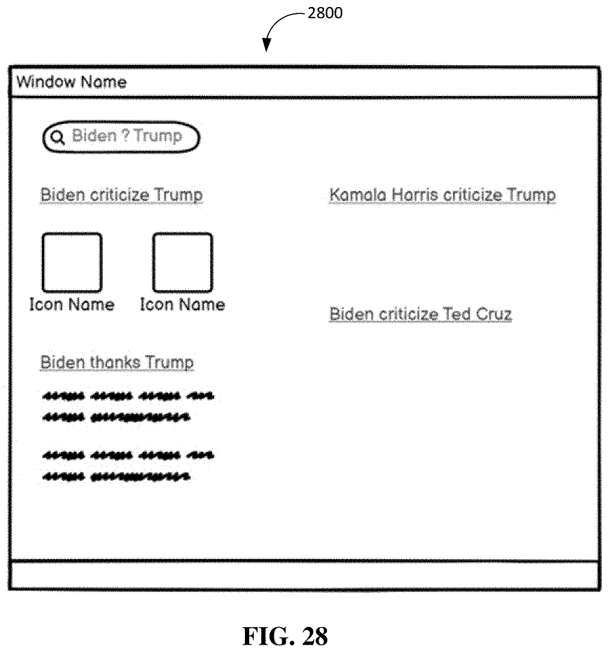

FIG. 28 is a screenshot of a user interface 2800 of the application for facilitating searching of entities and relationships, in accordance with some embodiments.

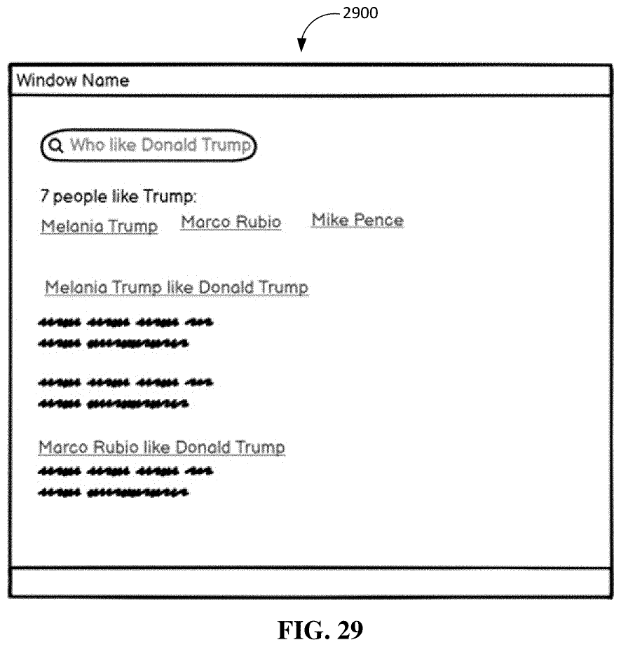

FIG. 29 is a screenshot of a user interface 2900 of the application for facilitating searching of entities and relationships, in accordance with some embodiments.

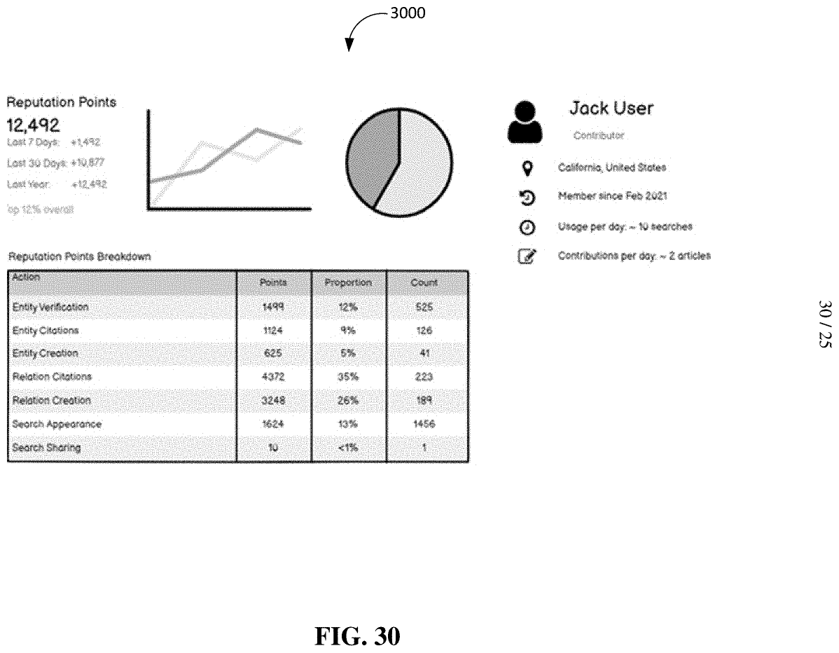

FIG. 30 is a screenshot of a summary report 3000 of the application, in accordance with some embodiments. Further, the summary report 3000 may include reputation points associated with a user. Further, the user may earn the reputation points. Further, the summary report 3000 represent an impact of the reputation point earned by the user on the community.

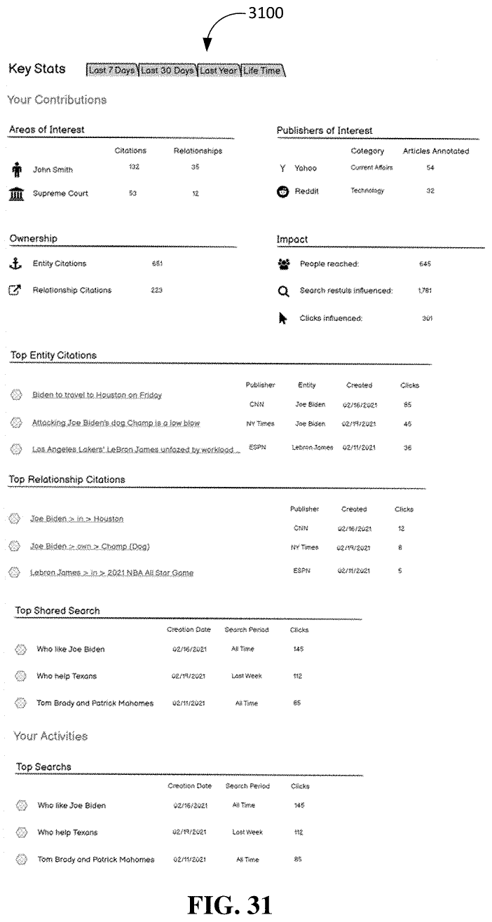

FIG. 31 is a screenshot of a key stats 3100 of the summary report 3000 of the application, in accordance with some embodiments.

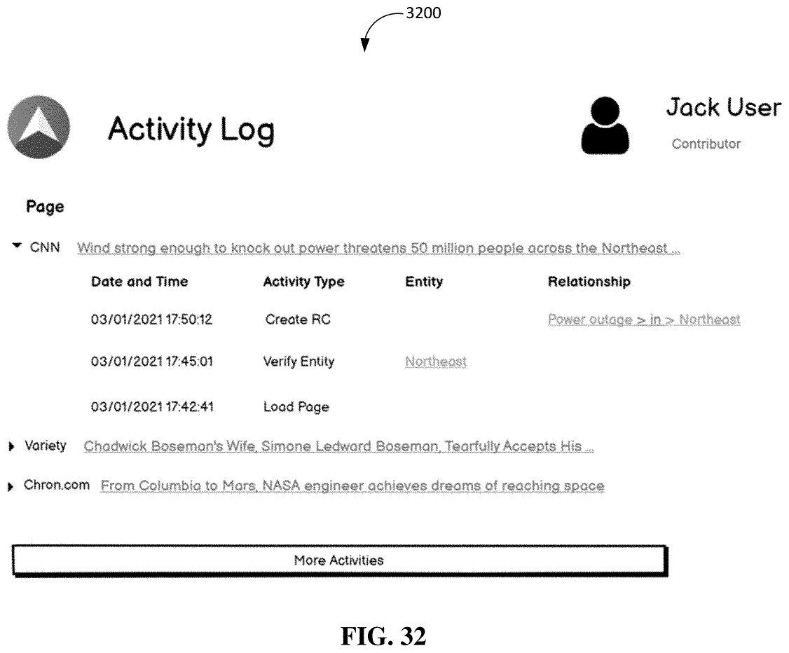

FIG. 32 is a screenshot of an activity log 3200 of the application, in accordance with some embodiments.

Although the present disclosure has been explained in relation to its preferred embodiment, it is to be understood that many other possible modifications and variations can be made without departing from the spirit and scope of the disclosure.

We claim:

1. A method for facilitating providing reliable and verifiable responses to queries, the method comprising:
receiving, using a communication device, at least one content associated with at least one webpage from at least one first device;
analyzing, using a processing device, the at least one content of the at least one webpage;
determining, using the processing device, at least two entities and at least one relationship between the at least two entities present in the at least one content based on the analyzing of the at least one content;
generating, using the processing device, a knowledge graph based on the at least two entities and the at least one relationship, wherein the knowledge graph comprises at least two nodes corresponding to the at least two entities and at least one edge connecting the at least two nodes corresponding to the at least one relationship between the least two entities, wherein the knowledge graph is searchable;
storing, using a storage device, the knowledge graph;
receiving, using the communication device, at least one query associated with the at least one content from at least one second device;
analyzing, using the processing device, the at least one query;
identifying, using the processing device, at least one of a search entity and a search relationship based on the analyzing of the at least one query;
generating, using the processing device, at least one response for the at least one query using the knowledge graph based on at least one of the search entity and the search relationship, wherein the at least one response is associated with at least one of the search entity and the search relationship; and
transmitting, using the communication device, the at least one response to the at least one second device.

2. The method of claim 1 further comprising:
searching, using the processing device, the knowledge graph based on at least one of the search entity and the search relationship; and
identifying, using the processing device, at least one of at least one related entity and a related relationship associated with the search entity, at least two related entities associated with the search relationship, and at least one related entity associated with the search entity and the search relationship based on the searching, wherein the generating of the at least one response is further based on at least one of the at least one related entity and the related relationship, the at least two related entities, and the at least one related entity.

3. The method of claim 1, wherein the at least one query comprises at least one of a search entity indication and a search relationship indication, wherein the identifying of at least one of the search entity and the search relationship is further based on at least one of the search entity indication and the search relationship indication.

4. The method of claim 1 further comprising:
transmitting, using the communication device, the at least two entities to the at least one second device;
receiving, using the communication device, at least one user relationship between the at least two entities from the at least one second device;
adding, using the processing device, at least one user connection corresponding to the at least one user relationship between the at least two nodes corresponding to the at least two entities;
generating, using the processing device, a modified knowledge graph based on the adding; and
storing, using the storage device, the modified knowledge graph, wherein the generating of the at least one response for the at least one query further uses the modified knowledge graph.

5. The method of claim 4 further comprising:
transmitting, using the communication device, a request for at least one supporting content for the at least one user relationship between the at least two entities to the at least one second device based on the receiving of the at least one user relationship;
receiving, using the communication device, the at least one supporting content from the at least one second device;
analyzing, using the processing device, the at least one supporting content;
determining, using the processing device, an authenticity of the at least one user relationship based on the analyzing of the at least one supporting content;
generating, using the processing device, at least one authenticity comment based on the determining of the authenticity;
associating, using the processing device, the at least one authenticity comment to at least one of the at least one supporting content and the at least one user relationship, wherein the generating of the knowledge graph is further based on the associating of the at least one authenticity comment, wherein the knowledge graph comprises the at least one authenticity comment; and
storing, using the storage device, the at least one supporting content and the at least one authenticity comment.

6. The method of claim 1 further comprising:
identifying, using the processing device, at least one supporting content for the at least one response;
generating, using the processing device, at least one supporting evidence for the at least one response based on the at least one supporting content, wherein the at least one supporting evidence verifies the at least one response for the at least one query; and
transmitting, using the communication device, the at least one supporting evidence to the at least one second device.

7. The method of claim 1 further comprising:
transmitting, using the communication device, the at least two entities and the at least one relationship between the at least two entities to the at least one second device;
receiving, using the communication device, at least one issue associated with at least two first entities of the at least two entities and at least one first relationship of the at least one relationship between the at least two first entities from the at least one second device, wherein the at least one issue corresponds to a discrepancy associated with the at least two first entities and the at least one first relationship;
flagging, using the processing device, the at least two first entities and the at least one first relationship between the at least two first entities based on the at least one issue;
transmitting, using the communication device, the at least two first entities, the at least one first relationship between the at least two first entities, and the at least one issue to at least one authorized device associated with at least one authorized user;
receiving, using the communication device, at least one review response associated with the at least two first entities and the at least one first relationship from the at least one authorized device; and
determining, using the processing device, an acceptability of the at least two first entities and the at least one first relationship between the at least two first entities based on the at least one review response, wherein the generating of the knowledge graph is further based on the determining of the acceptability.

8. The method of claim 1 further comprising determining, using the processing device, at least one attribute for each entity of the at least two entities based on the analyzing of the at least one content, wherein the at least one attribute of a first entity of the at least two entities uniquely maps the first entity to a second entity of the at least two entities using the at least one relationship, wherein the at least one attribute of the second entity uniquely maps the second entity to the first entity using the at least one relationship, wherein the generating of the knowledge graph is further based on the determining of the at least one attribute for the each entity, wherein the knowledge graph comprises the at least one attribute associated with the each entity.

9. The method of claim 8, wherein the at least one query comprises a search entity identifier, wherein the search entity identifier does not uniquely identify the search entity, wherein the identifying of the search entity comprises identifying a plurality of search entities associated with the search identifier, wherein the generating of the at least one response for the at least one query is further based on the each of the plurality of search entities, wherein the at least one response is further associated with the plurality of search entities.

10. The method of claim 1 further comprising:
analyzing, using the processing device, at least one of the search entity and the search relationship based on the identifying of at least one of the search entity and the search relationship;
determining, using the processing device, at least one characteristic of at least one of the search entity and the search relationship based on the analyzing of at least one of the search entity and the search relationship; and
generating, using the processing device, at least one of at least one suggested search entity and at least one suggested search relationship based on the determining of the at least one characteristic of at least one of the search entity and the search relationship, wherein the generating of the at least one response is further based on at least one of the at least one suggested search entity and the at least one suggested search relationship, wherein the at least one response is further associated with at least one of the at least one suggested search entity and the at least one suggested search relationship.

11. A system for facilitating providing reliable and verifiable responses to queries, the system comprising:
a communication device configured for:
receiving at least one content associated with at least one webpage from at least one first device;
receiving at least one query associated with the at least one content from at least one second device; and
transmitting at least one response to the at least one second device;
a processing device communicatively coupled with the communication device, wherein the processing device is configured for:
analyzing the at least one content of the at least one webpage;
determining at least two entities and at least one relationship between the at least two entities present in the at least one content based on the analyzing of the at least one content;
generating a knowledge graph based on the at least two entities and the at least one relationship, wherein the knowledge graph comprises at least two nodes corresponding to the at least two entities and at least one edge connecting the at least two nodes corresponding to the at least one relationship between the least two entities, wherein the knowledge graph is searchable;
analyzing the at least one query;
identifying at least one of a search entity and a search relationship based on the analyzing of the at least one query; and
generating the at least one response for the at least one query using the knowledge graph based on at least one of the search entity and the search relationship, wherein the at least one response is associated with at least one of the search entity and the search relationship; and
a storage device communicatively coupled with the processing device, wherein the storage device is configured for storing the knowledge graph;

12. The system of claim 11, wherein the processing device is further configured for:
searching the knowledge graph based on at least one of the search entity and the search relationship; and
identifying at least one of at least one related entity and a related relationship associated with the search entity, at least two related entities associated with the search relationship, and at least one related entity associated with the search entity and the search relationship based on the searching, wherein the generating of the at least one response is further based on at least one of the at least one related entity and the related relationship, the at least two related entities, and the at least one related entity.

13. The system of claim 11, wherein the at least one query comprises at least one of a search entity indication and a search relationship indication, wherein the identifying of at least one of the search entity and the search relationship is further based on at least one of the search entity indication and the search relationship indication.

14. The system of claim 11, wherein the communication device is further configured for:
transmitting the at least two entities to the at least one second device; and
receiving at least one user relationship between the at least two entities from the at least one second device, wherein the processing device is further configured for:
adding at least one user connection corresponding to the at least one user relationship between the at least two nodes corresponding to the at least two entities; and
generating a modified knowledge graph based on the adding, wherein the storage device is further configured for storing the modified knowledge graph, wherein the generating of the at least one response for the at least one query further uses the modified knowledge graph.

15. The system of claim 14, wherein the communication device is further configured for:
transmitting a request for at least one supporting content for the at least one user relationship between the at least two entities to the at least one second device based on the receiving of the at least one user relationship; and
receiving the at least one supporting content from the at least one second device, wherein the processing device is further configured for:
analyzing the at least one supporting content;
determining an authenticity of the at least one user relationship based on the analyzing of the at least one supporting content;
generating at least one authenticity comment based on the determining of the authenticity; and
associating the at least one authenticity comment to at least one of the at least one supporting content and the at least one user relationship, wherein the generating of the knowledge graph is further based on the associating of the at least one authenticity comment, wherein the knowledge graph comprises the at least one authenticity comment, wherein the storage device is further configured for storing the at least one supporting content and the at least one authenticity comment.

16. The system of claim 11, wherein the processing device is further configured for:
identifying at least one supporting content for the at least one response; and
generating at least one supporting evidence for the at least one response based on the at least one supporting content, wherein the at least one supporting evidence verifies the at least one response for the at least one query, wherein the communication device is further configured for transmitting the at least one supporting evidence to the at least one second device.

17. The system of claim 11, wherein the communication device is further configured for:
transmitting the at least two entities and the at least one relationship between the at least two entities to the at least one second device;
receiving at least one issue associated with at least two first entities of the at least two entities and at least one first relationship of the at least one relationship between the at least two first entities from the at least one second device, wherein the at least one issue corresponds to a discrepancy associated with the at least two first entities and the at least one first relationship;
transmitting the at least two first entities, the at least one first relationship between the at least two first entities, and the at least one issue to at least one authorized device associated with at least one authorized user; and
receiving at least one review response associated with the at least two first entities and the at least one first relationship from the at least one authorized device, wherein the processing device is further configured for:
flagging the at least two first entities and the at least one first relationship between the at least two first entities based on the at least one issue; and
determining an acceptability of the at least two first entities and the at least one first relationship between the at least two first entities based on the at least one review response, wherein the generating of the knowledge graph is further based on the determining of the acceptability.

18. The system of claim 11, wherein the processing device is further configured for determining at least one attribute for each entity of the at least two entities based on the analyzing of the at least one content, wherein the at least one attribute of a first entity of the at least two entities uniquely maps the first entity to a second entity of the at least two entities using the at least one relationship, wherein the at least one attribute of the second entity uniquely maps the second entity to the first entity using the at least one relationship, wherein the generating of the knowledge graph is further based on the determining of the at least one attribute for the each entity, wherein the knowledge graph comprises the at least one attribute associated with the each entity.

19. The system of claim 18, wherein the at least one query comprises a search entity identifier, wherein the search entity identifier does not uniquely identify the search entity, wherein the identifying of the search entity comprises identifying a plurality of search entities associated with the search identifier, wherein the generating of the at least one response for the at least one query is further based on the each of the plurality of search entities, wherein the at least one response is further associated with the plurality of search entities.

20. The system of claim 11, wherein the processing device is further configured for:
analyzing at least one of the search entity and the search relationship based on the identifying of at least one of the search entity and the search relationship;
determining at least one characteristic of at least one of the search entity and the search relationship based on the analyzing of at least one of the search entity and the search relationship; and
generating at least one of at least one suggested search entity and at least one suggested search relationship based on the determining of the at least one characteristic of at least one of the search entity and the search relationship, wherein the generating of the at least one response is further based on at least one of the at least one suggested search entity and the at least one suggested search relationship, wherein the at least one response is further associated with at least one of the at least one suggested search entity and the at least one suggested search relationship.
